(19) United States
(12) Patent Application Publication
(10) Pub. No.: US 2023/0326095 A1
(43) Pub. Date: Oct. 12, 2023

(54) OVERLAYING DISPLAYED DIGITAL CONTENT WITH REGIONAL TRANSPARENCY AND REGIONAL LOSSLESS COMPRESSION TRANSMITTED OVER A COMMUNICATION NETWORK VIA PROCESSING CIRCUITRY

(71) Applicant: MOBEUS INDUSTRIES, INC., Sparta, NJ (US)

(72) Inventors: Dharmendra ETWARU, Sparta, NJ (US); Aram ANDRIASYAN, Yerevan (AM)

(73) Assignee: MOBEUS INDUSTRIES, INC., Sparta, NJ (US)

(21) Appl. No.: 18/298,247

(22) Filed: Apr. 10, 2023

Related U.S. Application Data
(60) Provisional application No. 63/329,076, filed on Apr. 8, 2022.

(51) Int. Cl. G06T 11/00; G06T 7/174; G06T 1/60

(52) U.S. Cl. CPC G06T 11/00; G06T 7/174; G06T 1/60; G06T 2210/62; G06T 2207/10016

(57) ABSTRACT

A method that includes accessing a frame buffer of graphics processing unit (GPU), analyzing a frame representing a section of a first stream of image data that is being displayed by the device, identifying a region in the first frame, analyzing a second frame representing a section of a second stream of image data that is being displayed by the device, identifying at least one substitute region in the second frame, wherein the substitute region is located in the second frame at a like location to a location of the region in the first frame, and overlaying the first stream of image data onto the second stream of image data to generate a composite stream of image data, wherein the substitute region is displayed in the location of the region in the composite stream of image data.

### CROSS-REFERENCE TO PRIOR APPLICATIONS

The present application claims priority to U.S. Provisional Application No. 63/329,076, filed Apr. 8, 2022, the entire content of which is incorporated by reference herein in its entirety for all purposes.

### BACKGROUND

### Field of the Disclosure

The present disclosure relates to overlaying digital content into displayed data via graphics processing circuitry.

### Description of the Related Art

Displayed data has traditionally been presented within the bounds of a two-dimensional geometric screen. The visual experience of such displayed data is thus lacking in dynamism that allows for the layering of functionality within a given display frame.

The foregoing “Background” description is for the purpose of generally presenting the context of the disclosure. Work of the inventors, to the extent it is described in this background section, as well as aspects of the description which may not otherwise qualify as prior art at the time of filing, are neither expressly or impliedly admitted as prior art against the present disclosure.

### SUMMARY

The foregoing paragraphs have been provided by way of general introduction, and are not intended to limit the scope of the following claims. The described embodiments, together with further advantages, will be best understood by reference to the following detailed description taken in conjunction with the accompanying drawings.

According to an embodiment, the present disclosure relates to a device including processing circuitry with a graphics processing unit (GPU), the processing circuitry configured to access a frame buffer of the GPU, analyze a first frame of the frame buffer of the GPU, the first frame representing a section of a first stream of image data that is being displayed by the device, identify a region in the first frame, analyze a second frame representing a section of a second stream of image data that is being displayed by the device, identify at least one substitute region in the second frame, wherein the substitute region is located in the second frame at a like location to a location of the region in the first frame, and overlay the first stream of image data onto the second stream of image data to generate a composite stream of image data, wherein the substitute region is displayed in the location of the region in the composite stream of image data.

According to an embodiment, the present disclosure relates to a method of creating a composite stream of image data, including accessing a frame buffer of a graphics processing unit (GPU), analyzing a first frame of the frame buffer of the GPU, the first frame representing a section of a first stream of image data that is being displayed by the device, identifying a region in the first frame, analyzing a second frame representing a section of a second stream of image data that is being displayed by the device, identifying at least one substitute region in the second frame, wherein the substitute region is located in the second frame at a like location to a location of the region in the first frame, and overlaying the first stream of image data onto the second stream of image data to generate a composite stream of image data, wherein the substitute region is displayed in the location of the region in the composite stream of image data.

According to an embodiment, the present disclosure relates to a non-transitory computer-readable storage medium for storing computer-readable instructions that, when executed by a computer, cause the computer to perform a method, the method including accessing a frame buffer of a graphics processing unit (GPU), analyzing a first frame of the frame buffer of the GPU, the first frame representing a section of a first stream of image data that is being displayed by the device, identifying a region in the first frame, analyzing a second frame representing a section of a second stream of image data that is being displayed by the device, identifying at least one substitute region in the second frame, wherein the substitute region is located in the second frame at a like location to the location of the region in the first frame, and overlaying the first stream of image data onto the second stream of image data to generate a composite stream of image data, wherein the substitute region is displayed in the location of the region in the composite stream of image data.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view of user devices communicatively connected to a server, according to an exemplary embodiment of the present disclosure;

FIG. 2A is a flow chart of a method of generating a reference patch and embedding the reference patch into displayed data, according to an exemplary embodiment of the present disclosure;

FIG. 2B is a flow chart of a sub-method of generating the reference patch, according to an exemplary embodiment of the present disclosure;

FIG. 2C is a flow chart of a sub-method of associating the surface area with secondary digital content, according to an exemplary embodiment of the present disclosure;

FIG. 2D is a flow chart of a sub-method of integrating the reference patch into the displayed data, according to an exemplary embodiment of the present disclosure;

FIG. 3A is a flow chart of a method of inspecting the reference patch, according to an exemplary embodiment of the present disclosure;

FIG. 3B is a flow chart of a sub-method of identifying the reference patch with unique identifiers corresponding to the surface area from the stream of data, according to an exemplary embodiment of the present disclosure;

FIG. 3C is a flow chart of a sub-method of associating the unique identifiers with digital content, according to an exemplary embodiment of the present disclosure;

FIG. 4A is a flow chart of a method of identifying the reference patch included in the displayed data and overlaying the secondary digital content into displayed data, according to an exemplary embodiment of the present disclosure;

FIG. 4B is a flow chart of a sub-method of identifying the reference patch with the unique identifiers corresponding to the surface area from the stream of data, according to an exemplary embodiment of the present disclosure;

FIG. 4C is a flow chart of a sub-method of associating the unique identifiers with digital content, according to an exemplary embodiment of the present disclosure;

FIG. 5A is an illustration of a display, according to an exemplary embodiment of the present disclosure;

FIG. 5B is an illustration of a reference patch within a frame of a display, according to an exemplary embodiment of the present disclosure;

FIG. 5C is an illustration of an augmentation within a frame of a display, according to an exemplary embodiment of the present disclosure;

FIG. 6A is an illustration of a display, according to an exemplary embodiment of the present disclosure;

FIG. 6B is an illustration of a display with regional transparency, according to an exemplary embodiment of the present disclosure;

FIG. 6C is an illustration of a display with adjustable regional transparency, according to an exemplary embodiment of the present disclosure;

FIG. 6D is an illustration of a display with intelligent regional transparency, according to an exemplary embodiment of the present disclosure;

FIG. 7A is an illustration of a display, according to an exemplary embodiment of the present disclosure;

FIG. 7B is an illustration of an enhanced composite image, according to an exemplary embodiment of the present disclosure;

FIG. 8 is a schematic of a user device for performing a method, according to an exemplary embodiment of the present disclosure;

FIG. 9 is a schematic of a hardware system for performing a method, according to an exemplary embodiment of the present disclosure;

FIG. 10 is a schematic of a hardware configuration of a device for performing a method, according to an exemplary embodiment of the present disclosure;

FIG. 11 is an example of transparent computing; and

FIG. 12 is a flow chart of a method of generating a composite image, according to an exemplary embodiment of the present disclosure.

### DETAILED DESCRIPTION

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

According to an embodiment, the present disclosure relates to augmentation of a digital user experience. The augmentation may include an overlaying of digital objects onto a viewable display area of a display. The display may be a display of a mobile device such as a smartphone, tablet, and the like, a display of a desktop computer, or another interactive display. The digital objects can include text, symbols images, videos, and other graphical elements, among others. The digital objects can be interactive. The digital objects can be associated with third-party software vendors.

According to one embodiment, the present disclosure is directed to creation and display of transparent video to augment the digital user experience. In a static image or video, the appearance of transparency is typically determined by an alpha channel. The alpha channel is an additional channel that stores pixel information along with the typical color channels (e.g., red-green-blue (RGB)). The value of the alpha channel for each pixel determines how transparent the pixel is, e.g., a value of 0 indicating full transparency, a value of 1 indicating full opacity, and a value in between 0 and 1 indicating the inverse of a degree of transparency. Image transparency is especially useful when viewing multiple images in layers. The layers are typically created in a single file or program, such as a photo editing software or a vector graphics software. The transparency of each pixel determines which portions of each image are visible at a given moment. Image transparency is typically limited to a single program or application. For example, transparency in a first image in a first application does not affect the appearance of a second image in a second application even if the second application and the first application are both being displayed. In one embodiment of the present disclosure, an image with transparency is used to create a composite image made of image data from multiple programs, windows, and/or sources. For example, the second image, or a region thereof (a substitute region), can be made visible through a transparent region in the first image. Embodiments of the disclosure can include systems and methods for modifying the composite image by accessing image data from the multiplicity of programs, windows, and/or sources.

There is currently no standardized system for rendering and displaying transparency in video. Many video codecs and file types do not support an alpha channel. In addition, introducing transparency into video can affect image quality. There is also currently no system for displaying video with adjustable gradations of transparency rather than just fully transparent or fully opaque. In one embodiment, a method or system is directed towards rendering and displaying video with regional transparency using a substitute region.

In order to realize the augmentation of a digital user experience, a reference patch can be used. In one embodiment, the reference patch or other visually detectable element may serve to indicate a position at which digital content is to be placed onto a display. In some embodiments and as described herein, the reference patch can include encoded information that can be used to retrieve digital content and place that digital content into a desired location or locations in displayed data. The digital content can include at least one digital object. The reference patch can be embedded within displayed data (such as, but not limited to, an image, a video, a document, a webpage, or any other application that may be displayed by an electronic device). The reference patch can include unique identifying data in the form of a unique identifier, a marker, or encoding corresponding to predetermined digital content. The reference patch can indicate to the electronic device the particular digital content that is to be displayed, the position at which the digital content is to be placed, and the size with which the digital content is to be displayed. Accordingly, when a portion of displayed data comprising the reference patch is visible, the corresponding augmentation can be overlaid on the current frame of the displayed data wherein the augmentation includes secondary digital content (i.e., content that is secondary to (or comes after) the primary displayed data), herein referred to as “digital content,” and/or digital objects. For example, an augmentation can include additional images to be displayed with the current frame of displayed data for a seamless visual experience.

In an embodiment, a window containing a portion of the displayed data (e.g., word processing document) to be augmented can provide a region, or a surface area, for augmentation resulting from an identified reference patch within the displayed data. The window may thereby function as an anchor for the digital content, indicating where digital content can be relatively arranged. In an embodiment, digital content can be realized within a viewable area of a device software application or may reside within an entire viewable display area of the display. For instance, if a user is viewing a portable document format (PDF) document, a reference patch corresponding to given digital content may be within a viewable area of the PDF document and the digital content can be generated in a corresponding window through which the PDF document is being viewed. Additionally or alternatively, the digital content can be generated within the entire viewable display area of the display and may not reside only within the corresponding window through which the PDF document is being viewed.

The above-described augmentations are particularly relevant to environments where the underlying content is static. Static content may include textual documents or slide decks. Often, the static content is stored locally in the electronic device. Due to its nature, the static content is not capable of being dynamically adjusted according to complex user interactions, in real-time, during a user experience. Such a digital user experience is cumbersome and inefficient. Thus, a heightened, augmented user experience is desired to provide increased convenience, engagement, and agility. The augmentations described herein reduce cumbrousness by providing a visual representation/aid of retrieved external digital content, and provide improved engagement of the user, agility of navigation through the displayed data, and overall performance of the user device.

Described herein is a device and method to incorporate a reference patch with encoded identifier attributes, where the reference patch serves as a conduit for delivering content into the displayed data.

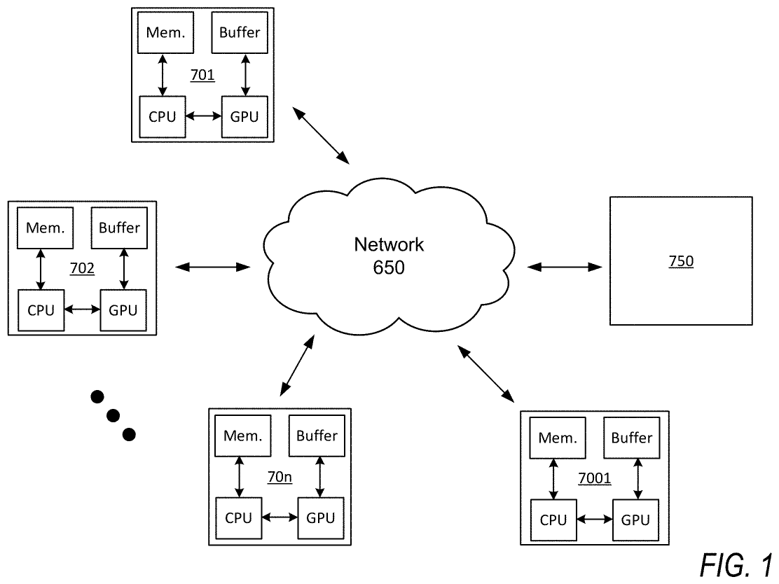

FIG. 1 is a schematic view of an electronic device, such as a client/user device (a first device 701) communicatively connected, via a network 650, to a second electronic device, such as a server (a networked device 750), and a generating device 7001, according to an embodiment of the present disclosure. Further, in an embodiment, additional client/user devices can be communicatively connected to both the first device 701 and the networked device 750. A second client/user device 702 can be communicatively connected to the first device 701 and the networked device 750. As shown, a plurality of the client/user devices can be communicatively connected to, for example, an nth user device 70n. The devices can be connected via a wired or a wireless network. In one embodiment, the first device 701 can be responsible for transmitting displayed data over the communication network 650 to the second client/user device 702 and/or the nth user device 70n.

An application may be installed or accessible on the first device 701 for executing the methods described herein. The application may also be integrated into the operating system (OS) of the first device 701. The first device 701 can be any electronic device such as, but not limited to, a personal computer, a tablet pc, a smart-phone, a smart-watch, an integrated AR/VR (Augmented Reality/Virtual Reality) headwear with the necessary computing and computer vision components installed (e.g., a central processing unit (CPU), a graphics processing unit (GPU), integrated graphics on the CPU, etc.), a smart-television, an interactive screen, a smart projector or a projected platform, an IoT (Internet of things) device or the like.

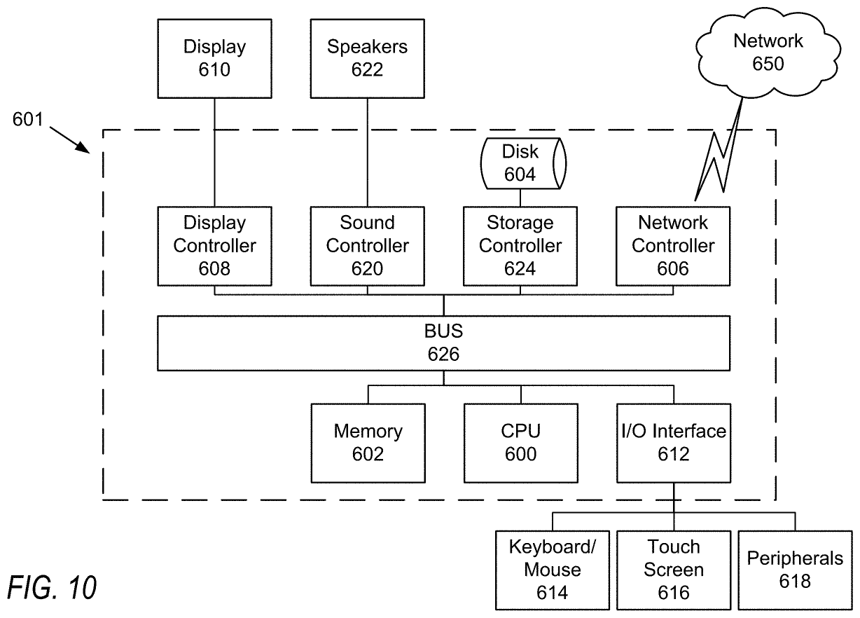

As illustrated in FIG. 1, the first device 701 includes a CPU, a GPU, a main memory, and a frame buffer, among other components (discussed in more detail in FIGS. 10-12). In an embodiment, the first device 701 can call graphics that are displayed on a display. The graphics of the first device 701 can be processed by the GPU and rendered in frames stored on the frame buffer that is coupled to the display. In an embodiment, the first device 701 can run software applications or programs that are displayed on a display. In order for the software applications to be executed by the CPU, they can be loaded into the main memory, which can be faster than a secondary storage, such as a hard disk drive or a solid state drive, in terms of access time. The main memory can be, for example, random access memory (RAM) and is physical memory that is the primary internal memory for the first device 701. The CPU can have an associated CPU memory and the GPU can have an associated video or GPU memory. The frame buffer can be an allocated area of the video memory. It can be understood that the CPU may have multiple cores or may itself be one of multiple processing cores in the first device 701. The CPU can execute commands in a CPU programming language such as C++. The GPU can execute commands in a GPU programming language such as HLSL. The GPU may also include multiple cores that are specialized for graphic processing tasks. Although the above description was discussed with respect to the first device 701, it is to be understood that the same description applies to the other devices (702, 70n, and 7001) of FIG. 1. Although not illustrated in FIG. 1, the networked device 750 can also include a CPU, GPU, main memory, and frame buffer.

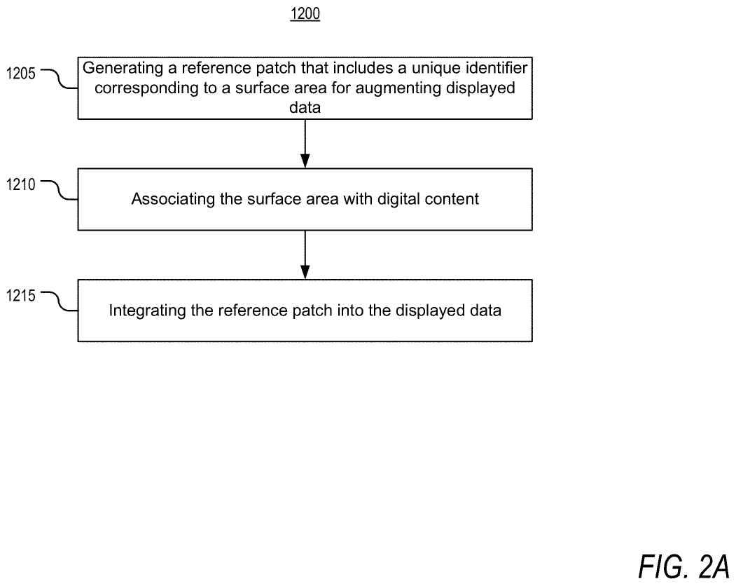

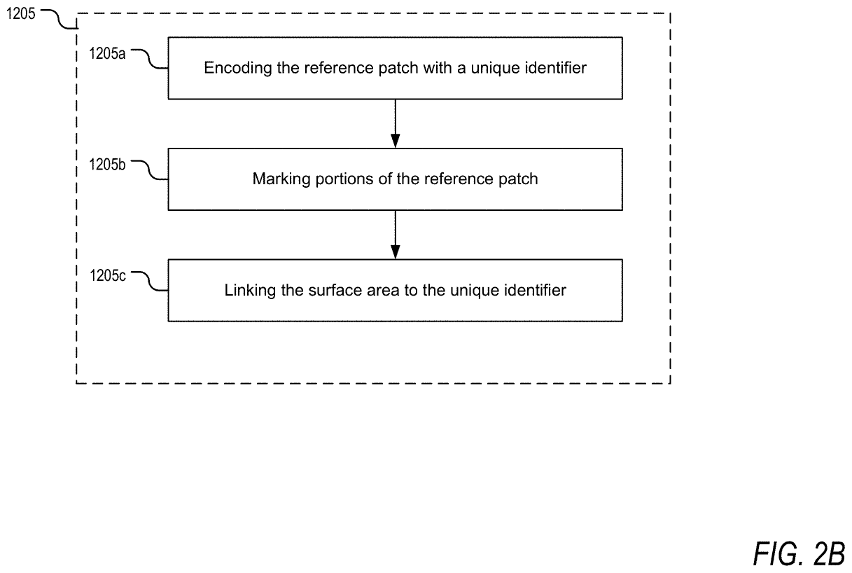

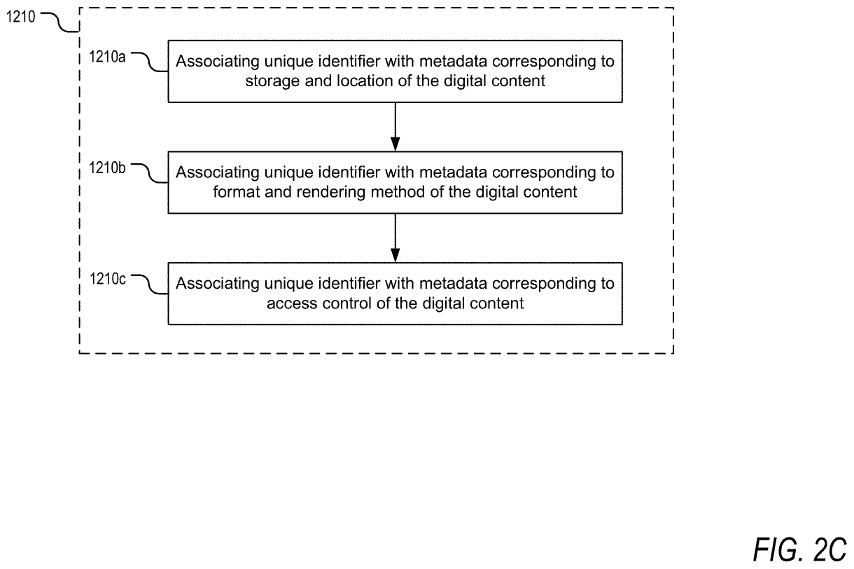

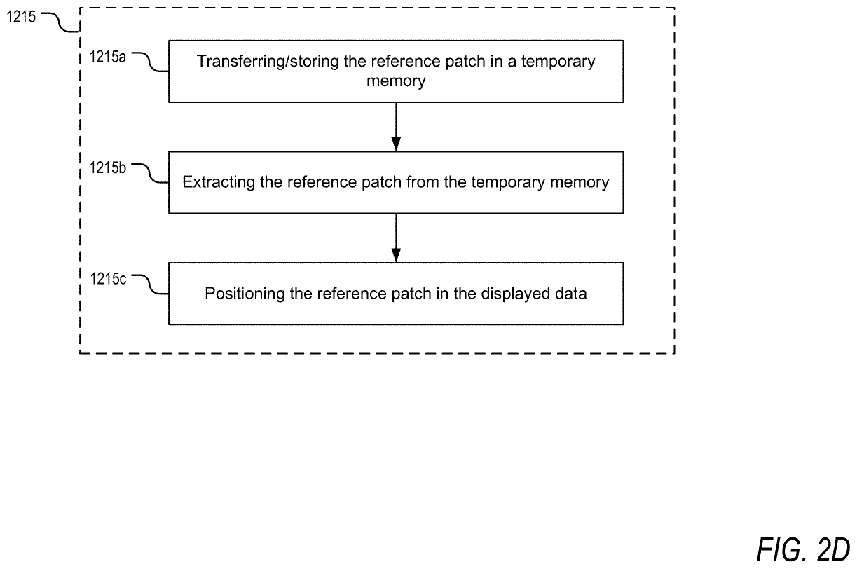

FIG. 2A is a flow chart for a method 1200 for generating a reference patch and embedding the reference patch into displayed data according to one embodiment of the present disclosure. The present disclosure describes generation of the reference patch and embedding of this patch into the displayed data content in order to integrate additional content. In an embodiment, the first device 701 can incorporate (secondary) digital content into what is already being displayed (displayed data) for a more immersive experience.

In this regard, the first device 701 can generate the reference patch in step 1205. The reference patch can be an object having an area and shape that is embedded in the displayed data at a predetermined location. For example, the reference patch can be a square overlayed and disposed in a corner of a digital document (an example of displayed data), wherein the reference patch can be fixed to a predetermined page for a multi-page (or multi-slide) digital document. The reference patch can thus also represent a surface area in the digital document. The reference patch can be an object that, when not in a field of view of the user, is inactive. The reference patch can, upon entering the field of view of the user, become active. For example, the reference patch can become active when detected by the first device 701 in the displayed data. When active, the reference patch can enable the first device 701 to retrieve digital content and augment the displayed data by incorporating the retrieved digital content into the displayed data. Alternatively, the reference patch can become active when located within the frame of the screen outputting the displayed data. For example, even if another window or popup is placed over top of the reference patch, the reference patch may continue to be active so long as the reference patch remains in the same location after detection and the window including the document incorporating the reference patch is not minimized or closed. As will be described further below, the reference patch can have a predetermined design that can be read by the first device 701, leading to the retrieval and displaying of the digital content.

In an embodiment, the first device 701 can use a geometrical shape for the reference patch and place the reference patch into displayed data using applications executed in the first device 701. The reference patch can take any shape such as a circle, square, rectangle or any arbitrary shape. In step 1210, the reference patch can also have predetermined areas within its shape for including predetermined data. The predetermined data can be, for example, unique identifiers that correspond to a surface area of the displayed data. In one embodiment, the unique identifier can include encoded data that identifies the digital content, a location address of the digital content (e.g., at the networked device 750), a screen position within the surface area at which the digital content is insertable in the displayed data, and a size of the digital content when inserted in the displayed data (adjustable before being displayed). In one embodiment, the unique identifier can include a marker. As will be described below, the marker can take the form of patterns, shapes, pixel arrangements, pixel luma, and pixel chroma, among others. Digital content can be displayed at the surface areas, or locations in the displayed data, corresponding to the unique identifier. In one embodiment, the surface areas are reference points for the relative location of digital content. In one embodiment, surface area refers to empty space wherein additional digital content can be inserted without obscuring displayed data. In one embodiment, the designation of empty space prioritizes preserving visibility of the reference patch.

For example, the first device 701 can use computer vision (described below) to detect displayed data. For example, the first device 701 can inspect an array to determine locations of objects in the displayed data. For example, a slide in a slide deck can include text, pictures, logos, and other media, and the surface area is the blank space or spaces around the aforementioned objects. Thus, the digital content can be displayed somewhere in the blank spaces. In an embodiment, the surface area of the displayed data can include portions of the displayed data that already include objects and the digital content can be displayed at the same location as the objects. For example, a slide in a slide deck can include a picture of a user, and the reference patch can be the area representing a face of the user and the additional digital content can be displayed at the same location as a body of the user. In another example, a slide in a slide deck can include an image of a vehicle wherein the image of the vehicle is the surface area for the digital content. The reference patch can be disposed in a blank space of the displayed data, and digital content retrieved (e.g., images of a new car paint color and new rims) as a result of the reference patch is displayed over the image of the vehicle to modify the appearance of the vehicle. In other words, the digital content may be placed in a blank area of the displayed data and/or in an area that is not blank (i.e., an area that includes text, image(s), video(s), etc.).

In step 1215, the first device 701 can embed the reference patch into the displayed data, such as a word processing document file (i.e., DOC/DOCX) provided by e.g., Microsoft® Word, in a Portable Document Format (PDF) file such as the ones used by Adobe Acrobat®, in a Microsoft® PowerPoint presentation (PPT/PPTX), or in a video sequence file such as MPEG, MOV, AVI or the like. These file formats are illustrative of some file types which a user may be familiar with; however, applications included in the first device 701 are not limited to these types and other applications and their associated file types are possible.

The reference patch (or similar element) can be embedded into any displayed data, where the displayed data may be generated by an application running on or being executed by the first device 701. The reference patch can encompass the whole area designated by the displayed data, or just a portion of the area designated by the displayed data. The method of generating the reference patch and embedding the reference patch into the displayed data has been described as being performed by the first device 701, however, the networked device 750 can instead perform the same functions. In order to be detected in the displayed data on the first device 701, the reference patch may only be simply displayed as an image on the screen. The reference patch may also simply be a raster image or in the background of an image. The reference patch is also able to be read even when the image containing the reference patch is low resolution. The reference patch can be encoded in a hardy and enduring manner such that even if a portion of the reference patch is corrupted or undecipherable, the reference patch can still be activated and used.

In an embodiment, the reference patch can be embedded inside of a body of an email correspondence. The user can use any electronic mail application such as Microsoft Outlook®, Gmail®, Yahoo®, etcetera. As the application is running on the first device 701, it allows the user to interact with other applications. In an embodiment, the reference patch can be embedded on a video streaming or two-way communication interface such as a Skype® video call or a Zoom® video call, among others. In an embodiment, the reference patch can be embedded in displayed data for multi-party communication on a live streaming interface such as Twitch®.

One way in which the first device 701 can embed the reference patch into the displayed data is by arranging the generated reference patch in the displayed data such as in a desired document or other media. The reference patch can include a facade of the digital content which becomes an integrated part of the displayed data. The facade can act as a visual preview to inform the user of the digital content linked to the reference patch. The facade can include, for example, a screenshot of a video to be played, a logo, an animation, or an image thumbnail, among others. In one embodiment, the facade can be an altered version of the digital content. For example, the facade is a more transparent version of the digital content. The facade can be a design overlay. The design overlay can be a picture that represents the digital content superimposed over the reference patch. In an embodiment, the facade can indicate the content that is represented by the reference patch. The facade can be contained within the shape of the reference patch or have a dynamic size. For example, attention of the user can be brought to the facade by adjusting the size of the facade when the reference patch is displayed. The adjustment of the size of the facade can also be dynamic, wherein the facade can enlarge and shrink multiple times. By the same token, a position and/or a rotation of the facade can also be adjusted to produce a shaking or spinning effect, for instance.

Unlike traditional means of sending displayed data, in one embodiment the first device 701 may not send the whole digital content with a header file (metadata) and a payload (data). Instead, the reference patch that may include a facade of the underlying digital content is placed within the displayed data. If a facade is present, it indicates to the first device 701 that the surface area can have digital content that can be accessed with selection (clicking with a mouse, touchpad, eye contact, eye blinks, or via voice command) of the facade. The digital content can also be accessed or activated automatically, e.g., when the reference patch is displayed on the display of the first device 701. Other means of visualization can be employed to indicate to the user that the surface area is likely to include information for obtaining digital content. For example, a highlighting effect can be applied along a perimeter of the reference patch with varying intensity to bring attention to the presence of the reference patch. As another example, dashed lines perpendicular to the perimeter of the reference patch can appear and disappear to provide a flashing effect. Other means can be employed to indicate to the user that the surface area is likely to include information for obtaining digital content, such as an audio cue.

The first device 701 employs further processes before embedding the reference patch into the displayed data. These processes and schemas are further discussed in FIG. 2B. FIG. 2B is a flow chart of a sub-method 1205 of generating the reference patch, according to an embodiment of the present disclosure. The first device 701 can associate the digital content with the surface area corresponding to the reference patch (e.g., via the unique identifiers included therein) generated by the first device 701. In an embodiment, the surface area may encompass the whole of the displayed data or a portion of it. The reference patch, which includes the unique identifiers corresponding to the surface area associated with the digital content, is then embedded into the displayed data by the first device 701. In some use cases, the displayed data including the reference patch can be sent or transmitted to the second client/user device 702 including the same application, which then allows the second client/user device 702 to access information within the surface area and obtain the digital content for display. That is, the second client/user device 702 can overlay the augmenting digital content on the displayed data on the display of the second client/user device 702 in the location or locations (surface areas) defined by the reference patch.

In FIG. 2B, the generating device 7001 uses additional processes to generate the reference patch, which is obtained and embedded by the first device 701. In an embodiment, the generating device 7001 encodes the reference patch with the unique identifiers corresponding to the surface area in step 1205a. The generating device 7001 can mark areas of the reference patch in step 1205b to form a marker. The marker can take the form of patterns, shapes, pixel arrangements, or the like. In an example, the marker can have a shape that corresponds to the shape of the surface area. In an example, the marker can have a size that corresponds to the size of the surface area. In an example, the marker can have a perimeter that corresponds to the perimeter of the surface area. The marker can use any feasible schema to provide identifying information that corresponds to the surface area within the displayed data. In an embodiment, the marker can incorporate hidden watermarks that are only detectable by the first device 701, which has detection functionality implemented therein, for example having an application installed or the functionality built into the operating system. The generating device 7001 can further link the surface area with unique identifiers in step 1205c. A unique identifier can be used to define or reference a surface area on the display. In one embodiment, the unique identifiers are used to set the content, position, sizing, and/or other visual properties of augmenting digital content. The unique identifiers can be hashed values (such as those described above) that are generated by the generating device 7001 when the reference patch is generated (such as the one having the area of the reference patch divided into the subset of squares).

The marker can incorporate patterns which can then be extracted by the first device 701. In an example, the first device 701 can perform the embedding, then send the displayed data having the embedded reference patch to the second client/user device 702. The encoding can be performed by the generating device 7001 and may use any variety of encoding technologies, such as those used to generate ArUco markers, to encode the reference patch by marking the reference patch with the marker. The first device 701 may also be used as the generating device 7001. In one embodiment, the networked device 750, the second client/user device 702, and/or the nth client/user device 70n can obtain, embed, and/or detect the reference patch from the generating device 7001.

In an embodiment, the marker can be comprised of a set of points. In one embodiment, the set of points can be equidistant from each other and/or make up equal angles when measured from a reference point, such as the center of the reference patch. That is, the fiducial points corresponding to the marker can provide a set of fixed coordinates or landmarks within the displayed data with which the surface area can be mapped. In an embodiment, the marker can be comprised of a set of unique shapes, wherein combinations of the unique shapes can correspond to a target surface area (or available area, or areas) for displaying the displayed data. The combinations of the unique shapes can also correspond to digital content for displaying in the surface area. The combinations of the unique shapes can also correspond to/indicate a position/location where the digital content should be displayed at the surface area relative to a portion of the surface area and/or the displayed data. A combination of the set of points and unique identifiers can be used as well. In one embodiment, pixel coordinates of the reference patch can be determined, and the objects can be displayed relative to the pixel coordinates of the reference patch.

For example, the unique identifiers can be unique shapes that correlate to digital content as well as indicating where the digital content should be overlayed on the display (the screen position). In one embodiment, the position of the digital content is determined relative to a set of points marked on the reference patch. The unique identifiers can also indicate a size of the digital content to be overlayed on the display, which can be adjustable based on the size of the surface area (also adjustable) and/or the size of the display of the first device 701. The unique identifiers can be relatively invisible or undetectable to the user, but readable by the first device 701 and cover predetermined areas of the reference patch. The unique identifiers, and by extension, the marker, can have an appearance that is different from an appearance of the area of the reference patch. In one embodiment, the unique identifiers use metamers or other visual effects such that the difference between the unique identifiers and the reference patch is only fully discernible by an electronic device. For example, the area of the reference patch can appear white to the user and the unique identifiers can also appear white to the user but may actually have a slightly darker pixel color that can be detected and interpreted by a device, such as the first device 701. In another example, the appearance of the unique identifiers can be 0.75% darker than the white color of the area of the reference patch. Such a small difference can be identified and discerned by the first device 701 while being substantially imperceptible to the user.

In an embodiment, the area of the reference patch can be divided into sections, for instance a set of squares, wherein a marker is included within each square. An example of a marker includes a letter. For example, a reference patch is divided into 16 squares, wherein each square is designated to represent different information, e.g., a timestamp, a domain, a version. Thus, the marker in each square is interpreted according to the designation of that square. An identification based on the set of squares can be, for example, an 18-character (or “letter”) hexadecimal. The set of squares can further include additional subsets for a randomization factor, which can be used for calculating a sha256 hash prior to encoding the reference patch with the hash. Together, the set of squares having the marker included therein can comprise the unique identifiers.

Moreover, the generating device 7001 can also employ chroma subsampling to mark the reference patch with attributes represented by a particular pattern. In an embodiment, the generating device 7001 can mark parts of the reference patch with predetermined patterns of pixel luma and chroma manipulation that represent a shape, a size, or a position of the surface area for displaying the digital content. In one embodiment, the generating device 7001 can mark a perimeter of the reference patch with a predetermined edging pattern of pixel luma and chroma manipulation that represents a perimeter of the surface area for displaying the digital content.

FIG. 2C is a flow chart of a sub-method of associating the surface area with digital content, according to an embodiment of the present disclosure. In FIG. 2C, the generating device 7001 uses additional processes to associate the surface area with digital content. In an embodiment, the generating device 7001 can associate the unique identifiers corresponding to the surface area with metadata. In step 1210a, the unique identifiers can be associated with metadata embodying information about the storage and location of the digital content. In step 1210b, the generating device 7001 can associate the unique identifier of the surface area with metadata which embodies information about the format and rendering information used for the digital content. In step 1210c, the generating device 7001 can associate the unique identifiers of the surface area with metadata which embodies access control information to the digital content.

In an embodiment, the storage of the digital content can be on a remote server, such as the networked device 750, and the location of the digital content can be the location address of the memory upon which it is stored at the remote server. The storage and location of the digital content can thus be linked with the metadata and/or the unique identifier wherein the metadata and/or the unique identifier point to how a device can obtain the digital content. The digital content is thus not directly embedded into the displayed data. In an embodiment, the format and rendering information about the digital content can be embodied in the metadata and associated with the unique identifiers. This information is helpful when the first device 701 or the second client/user device 702 are on the receiving end of the transmitted displayed data and need to properly retrieve and process the digital content.

Moreover, in an embodiment, the access control of the digital content can also be encompassed in the metadata and associated with the unique identifiers corresponding to the surface area. The access control can be information defining whether the digital content can be accessed by certain devices or users. In one embodiment, the access control is restricted by geographical location, time, date, device type, display type, software version, and/or operating system version. For example, a user may wish to restrict access to the digital content to certain types of devices, such as smartphone or tablets. Thus, the metadata defining a display requirement would encompass such an access control parameter. In one embodiment, the access control further includes how long a device can access the digital content, sharing settings, and/or password protection of the digital content.

FIG. 2D is a flow chart of a sub-method for integrating the reference patch into the displayed data, according to an embodiment of the present disclosure. In an embodiment, the generating device 7001 can temporarily transfer to or store the reference patch in a storage of the first device 701 in step 1215a. The storage can be accessed by the first device 701 for embedding the reference patch into the displayed data at any time. The first device 701 can extract the reference patch from the storage for embedding purposes in step 1215b. The first device 701 can also arrange the reference patch at a predetermined location and with a predetermined reference patch size in step 1215c. The first device 701 can further embed the reference patch such that a document, for example, having the reference patch embedded therein can be sent to a recipient, for example the second client/user device 702, where the second client/user device 702 can access the document using an application. Note that the features of the generating device 7001 can be performed by the first device 701.

The displayed data can be output from a streaming application or a communication application with a data stream having the reference patch embedded therein. The actual digital content may not be sent along with the underlying displayed data or data stream, but only the reference patch, the unique identifier, and/or a facade of the digital content is sent. In one embodiment, the unique identifier and/or the metadata can be stored in a database such as MySQL which can point to the networked device 750 or a cloud-based file hosting platform that houses the digital content. No limitation is to be taken with the order of the operation discussed herein; such that the sub-methods performed by the first device 701 can be carried out synchronous to one another, asynchronous, dependently or independently of one another, or in any combination. These stages can also be carried out in series or in parallel fashion.

There can be a plurality of ways to identify a reference patch within a frame of displayed data. In one embodiment, the displayed data can be stored in a frame buffer. A frame buffer is a segment of memory that stores pixel data as a bitmap, or an array of bits. Each pixel in the display is defined by a color value. The color value is stored in bits. In one embodiment, the frame buffer can include a color lookup table, wherein each pixel color value is an index that references a color on the lookup table. A frame buffer can store a single frame of displayed data or multiple frames of displayed data. In order to store multiple frames of displayed data, the frame buffer includes a first buffer and at least one additional buffer. A currently displayed frame of displayed data is stored in the first buffer, while at least one subsequent frame is stored in the at least one additional buffer. When the subsequent frame is displayed, the first buffer is then filled with new displayed data. Frame buffers can be stored in a graphics processing unit (GPU). In one embodiment, each of the plurality of second electronic devices (e.g., the first device 701, the second client/user device 702, the nth user device 70n) can access the frame buffer in the GPU and analyze the pixel data in order to identify a reference patch.

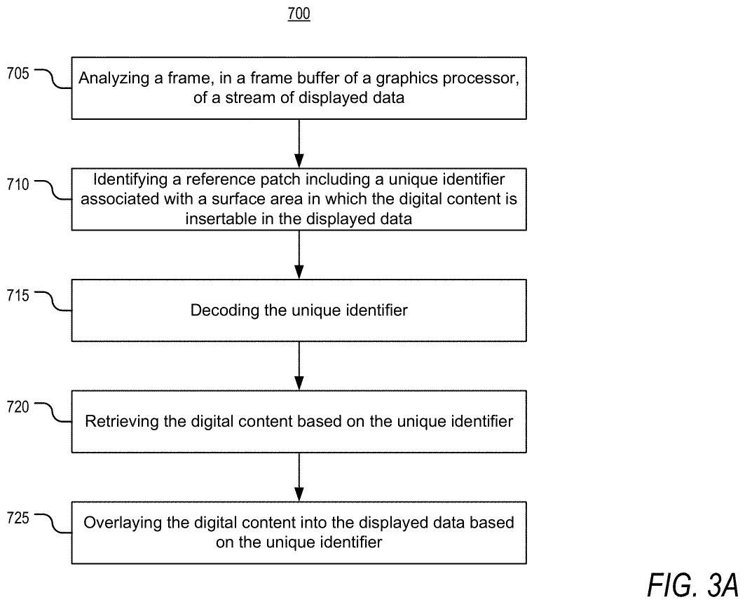

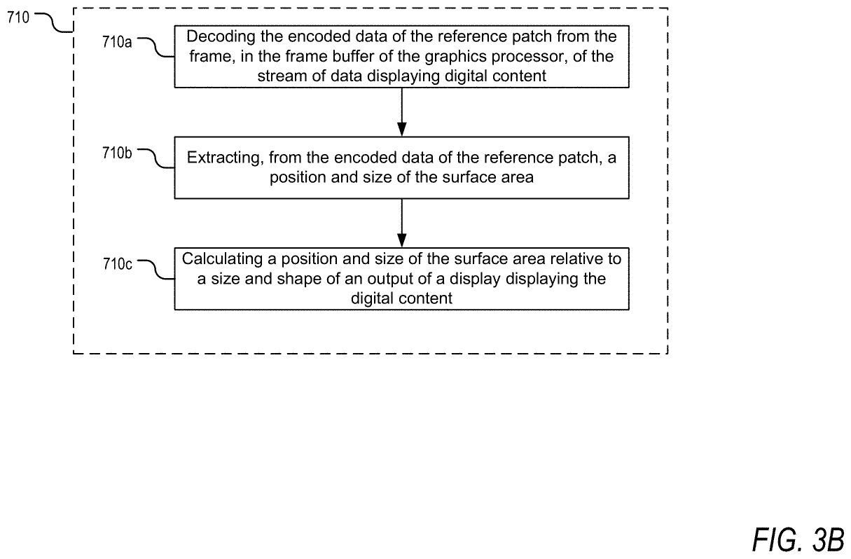

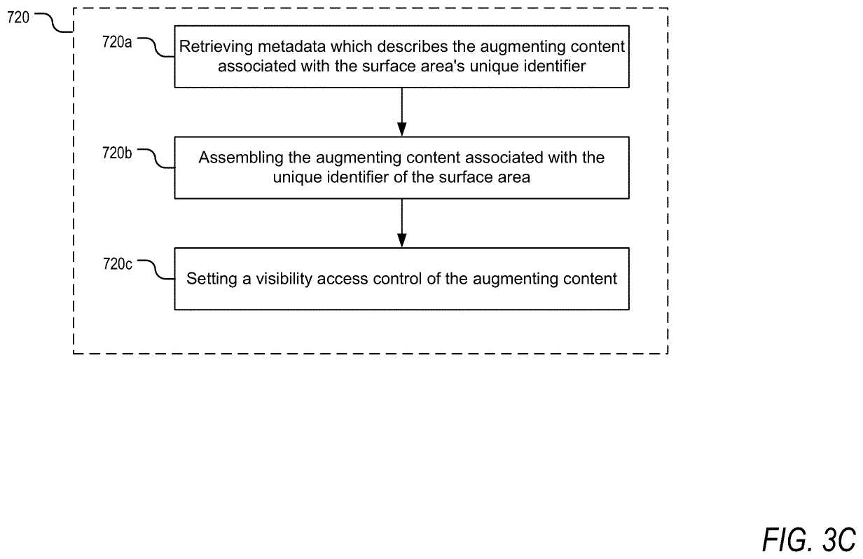

FIG. 3A is a flow chart for a method 700 of identifying the reference patch included in the displayed data and overlaying the digital content onto displayed data according to an embodiment of the present disclosure. In an embodiment, in step 705, the first device 701 can inspect the stream of data being outputted by the first device's 701 video or graphics card and onto the display of the first device 701. That is, the first device 701 can access a frame buffer of the GPU and analyze, frame by frame, in the frame buffer, the outputted stream of data which can include the displayed data. In an embodiment, a frame represents a section of the stream of the displayed data that is being displayed by the first device 701. In that regard, the first device 701 can inspect the outputted stream of data. The first device 701 can achieve this by intercepting and capturing data produced from the first device 701's video card or GPU that is communicated to the first device 701's display. Inspecting the frame buffer is a method for visually identifying the reference patch as part of the display content.

In an embodiment, in step 710, the first device 701 can process attributes of each pixel included in a single frame and detect groups of pixels within that frame with a known predetermined pattern of pixel luma and chroma manipulation in order to find the reference patch. In one embodiment, the first device 701 can identify the reference patch based on a confidence level for a predetermined pattern of pixel luma and chroma manipulation and/or a predetermined edge pattern of pixel luma and chroma manipulation. For example, the first device 701 can identify a reference patch wherein the reference patch is a uniform gray rectangle surrounded by a white background. The pattern of chroma manipulation of gray rectangle in contrast with the surrounding pixel data is identifiable as a reference patch. In another embodiment, the first device 701 can identify a line segment separating a reference patch from the remainder of the displayed data based on the color and/or brightness of the line segment. In one embodiment, the first device 701 can inspect pixels in batches. In one embodiment, identifying the reference patch is done by inspecting the frame buffer using computer vision, including, but not limited to, image recognition, semantic segmentation, edge detection, pattern detection, object detection, image classification, and/or feature recognition. Examples of artificial intelligence computing systems and techniques used for computer vision include, but are not limited to, artificial neural networks (ANNs), generative adversarial networks (GANs), convolutional neural networks (CNNs), thresholding, and support vector machines (SVMs). Computer vision is useful when the displayed data includes complex imagery and/or when the reference patch would otherwise blend into the displayed data. For example, an image of a car is a reference patch, and the displayed data includes multiple images of cars. Computer vision enables the first device 701 to accurately identify the specific image of the car that is the reference patch in the displayed data.

In a non-limiting example, the processor-based computer vision operation can include sequences of filtering operations, with each sequential filtering stage acting upon the output of the previous filtering stage. For instance, when the processor is a graphics processing unit (GPU), these filtering operations are carried out by fragment programs. In the event an input to the operation is an image, the input images are initialized as textures and then mapped onto quadrilaterals. Displaying the input in quadrilaterals ensures a one-to-one correspondence of image pixels to output fragments. Similarly, when the input to the operation is an encoded image, a decoding process may be integrated into the processing steps described above. A complete computer vision algorithm can be created by implementing sequences of these filtering operations. After the texture has been filtered by the fragment program, the resulting image is placed into texture memory, either by using render-to-texture extensions or by copying the frame buffer into texture memory. In this way, the output image becomes the input texture to the next fragment program. This creates a pipeline that runs the entire computer vision algorithm. However, often a complete computer vision algorithm will require operations beyond filtering. For example, summations are common operations. Furthermore, more-generalized calculations, such as feature tracking, can also be mapped effectively onto graphics hardware.

In an embodiment, the reference patch can be identified by use of edge detection methods. In an example, the edge detection method may be a Canny edge detector. The Canny edge detector may be run on the GPU. In one instance, the Canny edge detector can be implemented as a series of fragment programs, each perform a step of the algorithm.

In an embodiment, the identified reference patch can be tracked from frame to frame using feature vectors. Calculating feature vectors at detected feature points is a common operation in computer vision. A feature in an image is a local area around a point with some higher-than-average amount of “uniqueness.” This makes the point easier to recognize in subsequent frames of video. The uniqueness of the point is characterized by computing a feature vector for each feature point. Feature vectors can be used to recognize the same point in different images and can be extended to more generalized object recognition techniques.

Feature detection can be achieved using methods similar to the Canny edge detector that instead search for corners rather than lines. If the feature points are being detected using sequences of filtering, the GPU can perform the filtering and read back to the central processing unit (CPU) a buffer that flags which pixels are feature points. The CPU can then quickly scan the buffer to locate each of the feature points, creating a list of image locations at which the feature vectors will be calculated on the GPU.

In step 715, the first device 701 can decode the encoded unique identifier included with the reference patch wherein the unique identifier corresponds to a surface area for augmentation. In one embodiment, a reference patch includes a plurality of unique identifiers. In one embodiment, the unique identifier is a hashed value. In one embodiment, the unique identifier was generated by the first device 701. In one embodiment, the unique identifier was generated by an external device, e.g., the networked device 750, the second client/user device 702, the nth user device 70n.

In step 720, the first device 701 uses the unique identifier to retrieve digital content. In one embodiment, the unique identifier describes the content, the location address, metadata, or other identifying information about the digital content. In one embodiment, the first device 701 retrieves the digital content from a server, e.g., the networked device 750. In one embodiment, the first device 701 retrieves the digital content from main memory.

In step 725, the first device 701 overlays digital content as an augmentation of the displayed data. In one embodiment, the location of the digital content is the surface area described by the unique identifier. The digital content is overlaid as an additional layer to the displayed data. Although the digital content is visually merged with the displayed data, the data itself is isolated from the displayed data and can be modified independently of the rest of the displayed data.

Again, the method of identifying the reference patch included in the displayed data and augmenting the displayed data is described as performed by the first device 701, however, the networked device 750 can instead perform the same functions.

In an embodiment, the first device 701 identifies the surface area corresponding to the reference patch by employing further processes to process the frames. To this end, FIG. 3B is a flow chart of a sub-method of identifying the reference patch with the unique identifiers corresponding to the surface area from the stream of data, according to an embodiment of the present disclosure.

In step 710a, the first device 701 can decode the encoded reference patch from the frame. The encoded reference patch can include the marker that makes up the unique identifiers within the reference patch incorporated previously. The reference patch can also include other identifying information. The marker can be disposed within the reference patch, such as within the area of the reference patch or along a perimeter of the reference patch, or alternatively, outside of the area of the reference patch.

Whatever schema is used to encode the marker in the reference patch is also used in reverse operation to decode the underlying information contained within the reference patch. As stated above, in an embodiment, the encoded marker can be patterns generated and decoded using the ArUco algorithm or by other algorithms that encode data according to a predetermined approach.

In step 710b, the first device 701 can also extract attributes of the surface area from the reference patch. In an embodiment, the position, size, shape, and perimeter of the surface area are extracted, although other parameters can be extracted as well. Other parameters include boundary lines, area, angle, depth of field, distance, ratio of pairs of points, or the like. In an embodiment, where shape and perimeter are designated as the attributes, the first device 701 makes determinations of size, shape, and perimeter and outputs that result. Specifically, the size or shape of the surface area can be determined by evaluating a predetermined or repeatable pattern of pixel luma and chroma manipulation in the reference patch. The predetermined pattern can be marked on, within the area, or outside of the area of the reference patch. The predetermined pattern can correspond to the size or shape of the surface area. The predetermined pattern can correspond to the size or shape of the digital content. The perimeter of the surface area can also be determined by evaluating a predetermined edging pattern of pixel luma and chroma manipulation. The predetermined edging pattern can be marked on, within the area, or outside of the area of the reference patch. That is, the predetermined edging pattern of the refence patch can correspond to the perimeter of the surface area. The predetermined edging pattern of the refence patch can correspond to the perimeter of the digital content.

In step 710c, the first device 701 can also calculate a position and size of the surface area relative to the size and shape (dimensions) of the output signal from the display that is displaying the displayed data. In an embodiment, the calculating of the size, relative to the size and shape of the outputted signal from the display, includes determining the size of the surface area by inspecting a furthest measured distance between the edges of the surface area. Furthermore, the calculating of a location of the surface area, relative to the size and shape of the outputted signal from the display, includes determining the location of the surface area relative to the size and shape of the displayed data outputted through the display. This includes calculating the distance between the outer edges of the surface area and the inner edges of the displayed data being outputted by the display. The determined size and location of the surface area can be outputted as a result. Notably, prior to overlaying the digital content into the displayed data, the first device 701 can adjust, based on the predetermined pattern and the predetermined edging pattern, the size and perimeter of the digital content for displaying in the display of the first device 701. For example, the size and perimeter of the digital content for displaying in the display of the first device 701 can be scaled based on the size and perimeter of the surface area and/or the size of the display.

The first device 701 can provide information regarding the characteristics of the output video signal, such that the digital content that is later overlaid can correctly be displayed to account for various manipulations or transformations that may take place due to hardware constraints, user interaction, image degradation, or application intervention. Such manipulations and transformations may be the relocation, resizing, and scaling of the reference patch and/or the surface area, although the manipulations and transformations are not limited to those enumerated herein.

In an embodiment, the reference patch itself can be used as the reference for which the digital content is displayed on the surface area. In one example, the location at which to display the digital content in the surface area can be determined relative to the location of the reference patch on the displayed data. In one example, the size of the surface area can be determined relative to the size of the reference patch on the displayed data. In an example employing a combination of the two properties of the reference patch, the reference patch displayed in the displayed data on a smart phone having a predetermined size and a surface area can be scaled relative to the predetermined size of the display of the smart phone. This can be further adjusted when the reference patch in the same displayed data is displayed on a desktop monitor, such that the predetermined size of the reference patch in the displayed data displayed on the desktop monitor is larger and thus the size of the surface area can be scaled to be larger as well. Furthermore, the location of the surface area can be determined via a function of the predetermined size of the reference patch. For example, the location at which to display the digital content in the surface area can be disposed some multiple widths laterally away from the location of the reference patch as well as some multiple heights longitudinally away from the location of the reference patch. As such, the predetermined size of the reference patch can be a function of the size of the display of the first device 701. For example, the predetermined size of the reference patch can be a percentage of the width and height of the display, and thus the location and the size of the surface area are also a function of the width and height of the display of the first device 701.

In an embodiment, the first device 701 can determine an alternative location at which to display the digital content based on behaviors of the user. For example, the first device 701 can compare the encoded data corresponding to the location at which to display the digital content in the surface area to training data describing movement and focus of the user's eyes while viewing the displayed data. Upon determining the location at which to display the digital content in the surface area (as encoded in the reference patch) is not the same as the training data, the first device 701 can instead display the digital content at the location described by the training data as being where the user's eyes are focused in the displayed data at a particular time. For example, the user's eyes may be predisposed to viewing a bottom-right of a slide in a slide deck. The first device 701 can decode the reference patch and determine the digital content is to be displayed in a bottom-left of the slide deck. The training data can indicate that, for example, the user's eyes only focus on the bottom-left of the slide 10% of the time, while user's eyes focus on the bottom-right of the slide 75% of the time. Thus, the first device 701 can then display the digital content in the bottom-right of the slide instead of the bottom-left. The training data can also be based on more than one user, such as a test population viewing a draft of the slide deck. For example, the training data can be based on multiple presentations of the slide deck given to multiple audiences, wherein eye tracking software determines the average location of the audience's focus on each of the slides.

In an embodiment, the first device 701 employs other processes to associate the unique identifiers with the digital content. To this end, FIG. 3C is a flow chart of a sub-method of associating the unique identifiers with digital content, according to an embodiment of the present disclosure. In step 720a, the first device 701 can send the unique identifiers to the networked device 750 and the networked device 750 can retrieve metadata that describes the digital content, the digital content being associated with the surface area through the unique identifiers. This can be done by querying a remote location, such as a database or a repository, using the unique identifiers of the surface area as the query key. In an embodiment, the first device 701 sends the unique identifiers to the networked device 750 and the networked device 750 associates the unique identifier of the reference patch to corresponding digital content based on the metadata. The metadata associated with the surface area's unique identifier can be transmitted to the first device 701 with the augmentation content.

In step 720b, the first device 701 can assemble the digital content that is associated with the surface area's unique identifier. The assembly can entail loading the necessary assets for assembling the digital content. In an embodiment, this can entail loading manipulation software or drivers in order to enable the first device 701 to process the digital content. Other assembling processes can be the loading of rendering information in order to transform and manipulate an individual portion of the digital content. Furthermore, the loaded manipulation software, drivers, or rendering information can be used to compile all the individual portions of the entire digital content together. In an embodiment, this can include adapting the file formats of the digital content, delaying the playback for the digital content, converting from one format to another, scaling the resolution up or down, converting the color space, etc.

In step 720c, the first device 701 can provide access control parameters for the digital content. The access control parameters can dictate whether the digital content is visible to some users, or to some geographical locations, or to some types of displays and not others, as well as the date and time or duration of time a user can access the digital content. In an embodiment, visibility of the digital content can be defined for an individual. For example, the digital content can be a video that is appropriate for users over a certain age. In an embodiment, visibility of the digital content can be defined for a geographic location. For example, the digital content can be a video that is region-locked based on a location of the first device 701. In an embodiment, visibility of the digital content can be defined for a type of display displaying the displayed data. For example, the digital content can be VR-based and will only display with a VR headset. In an embodiment, visibility of the digital content can be defined for a predetermined date and a predetermined time. For example, the digital content can be a video that will only be made publicly available after a predetermined date and a predetermined time. In an embodiment, visibility of the digital content can be defined for a time period. For example, the digital content can be a video that is only available for viewing during a holiday. The first device 701 thus calculates the user's access level based on those parameters and provides an output result as to the user's ability to access the digital content, i.e., whether the digital content will be visible or invisible to the user. Note that the access control parameters can be global, for all the displayed data, or it can be localized per surface area and the underlying digital content.

Referring again to FIG. 3A, in step 725, the first device 701 can carry on the processes of overlaying the surface area with the digital content into the displayed data in accordance with the surface area, the position, and the size identified by the unique identifier. The first device 701 can determine or adjust the size and location of the assembled digital content on the surface area relative to the size and shape of the displayed data being outputted by the display. Then, the first device 701 can render the associated digital content (or the assembled individual portions) over the surface area's shape and perimeter using the size and location information. Thus, the digital content is superimposed on top of the surface area.

In one embodiment, a device (e.g., the first device 701) can inspect the memory of the device in order to identify the reference patch. A frame buffer stores a limited number of frames of displayed data. Displayed data can also be stored in the main memory of a device, wherein the main memory refers to internal memory of the device. The operating system (OS) and software applications can also be stored in the main memory of a device.

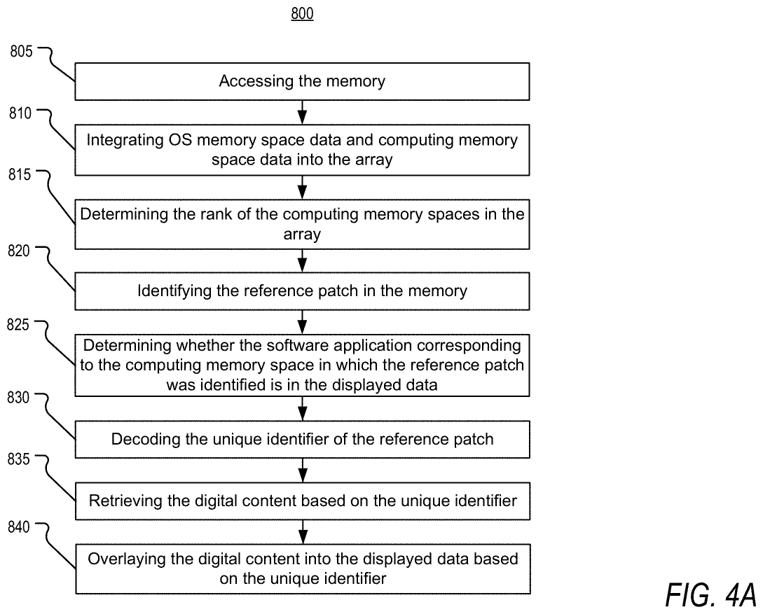

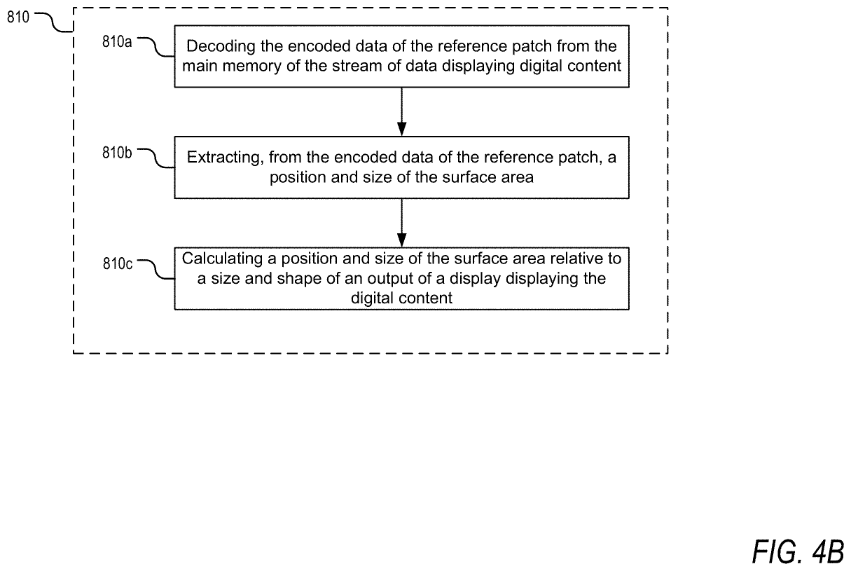

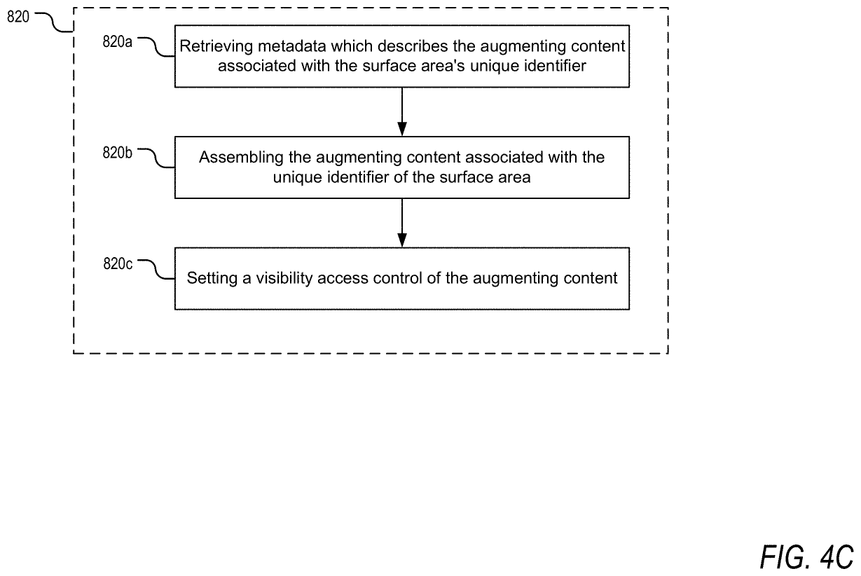

FIG. 4A is a flow chart for a method 800 of identifying the reference patch included in the displayed data and overlaying the digital content into displayed data, according to an embodiment of the present disclosure. In an embodiment, in step 805, the first device 701 can inspect the main memory on the first device 701. Again, the main memory of the first device 701 refers to physical internal memory of the first device 701 where all the software applications are loaded for execution. Sometimes complete software applications can be loaded into the main memory, while other times a certain portion or routine of the software application can be loaded into the main memory only when it is called by the software application. The first device 701 can access the main memory of the first device 701 including an operating system (OS) memory space, a computing memory space, and an application sub-memory space for the computing memory space in order to determine, for example, which software applications are running (computing memory space), how many windows are open for each software application (application sub-memory space), and which windows are visible and where they are located (or their movement) on the display of the first device 701 (OS memory space). That is to say, the OS memory takes up a space in (or portion of) the main memory, the computing memory takes up a space in (or portion of) the main memory, and the application sub-memory takes up a space in (or portion of) the computer memory. This information can be stored, for example, in the respective memory spaces. Other information related to each software application can be obtained and stored and is not limited to the aforementioned features.

In an embodiment, in step 810, the first device 701 can aggregate the various memory spaces into an array (or table or handle). That is, the first device 701 can integrate data corresponding to the OS memory space and data corresponding to the computing memory space into the array. The array can be stored on the main memory of the first device 701 and include information regarding the software applications running on the first device 701. In an embodiment, the computing memory spaces (including the application sub-memory spaces) can be aggregated into the array. This can be achieved by querying the main memory for a list of computing memory spaces of all corresponding software applications governed by the OS and aggregating all the computing memory spaces obtained from the query into the array. This can be, for example, aggregating the computing memory space of a PowerPoint file and the computing memory space of a Word file into the array. The information in the computing memory spaces stored in the array can include metadata of the corresponding software application. For example, for PowerPoint, the information in the array can include a number of slides in a presentation, notes for each slide, etc. Moreover, each window within the PowerPoint file and/or the Word file can be allocated to a sub-memory space. For example, the array can include the location of each window for each software application running on the first device 701, which can be expressed as an x- and y-value pixel coordinate of a center of the window. For example, the array can include the size of each window for each software application running on the first device 701, which can be expressed as a height and a width value.

In an embodiment, in step 815, the first device 701 can determine a rank or a hierarchy of the computing memory spaces in the array. The rank can describe whether a window of a software application or the software application itself is active or more active as compared to another software application running on the first device 701. An active window or software application can correspond to the window or software application that is currently selected or clicked in or maximized. For example, an active window can be a window of a web browser that the user is scrolling through. In an embodiment, this can be achieved by querying the OS memory space and each computing memory space in the main memory for existing sub-memory spaces, querying the OS memory space and each computing memory space in the main memory for a rank or hierarchical relationship between (software application) sub-memory spaces found, recording the list of sub-memory spaces and the rank relationship between sub-memory spaces, and associating the list of sub-memory spaces and the rank relationship between the sub-memory spaces with the array. For example, a window of a first application can be an active window on the first device 701 and has a higher rank than an inactive window of a second application also running on the first device 701. The active window can be the window the user has currently selected and displayed over all other windows on the display of the first device 701. Notably, there can be multiple visible windows, but one of said multiple visible windows can have a higher rank because it is currently selected by the user and the active window.

For example, two documents can be viewed in a split-screen side-by-side arrangement without any overlap of one window over another window, and a third document can be covered by the two documents in the split-screen side-by-side arrangement. In such an example, the user can have one of the two split-screen documents selected, wherein the selected document is the active window and would have a higher rank (the highest rank) than the other of the two split-screen documents since the higher (highest) ranked document is selected by the user. The third document behind the two split-screen documents would have a lower rank (the lowest rank) than both of the two split-screen documents since it is not visible to the user. Upon bringing the third document to the front of the display and on top of the two split-screen documents, the third document rank would then become the highest rank, while the two split screen documents' rank would become lower (the lowest) than the third document (and the rank of the two split screen documents can be equal).

In an embodiment, the rank can be determined based on eye or gaze tracking of the user (consistent with or independent of whether a window is selected or has an active cursor). For example, a first window and a second window can be visible on the display, wherein the first window can include a video streaming from a streaming service and the second window can be a word processing document. The rank of the first window and the second window can be based on, for example, a gaze time that tracks how long the user's eyes have looked at one of the two windows over a predetermined time frame. The user may have the word processing document selected and active while the user scrolls through the document, but the user may actually be watching the video instead. In such a scenario, an accrued gaze time of the first window having the video can be, for example, 13 seconds out of a 15 second predetermined time frame, with the other 2 seconds in the predetermined time frame being attributed to looking at the first window having the word processing document. Thus, the rank of the first window having the video can be higher than the rank of the second window because the gaze time of the first window is higher than the gaze time of the second window. Notably, if there is only one open window, the rank of that window would be ranked as the top-ranked window (because it is the only window) regardless of/independent from other user input, such as gaze, selection, etc.

In an embodiment, the rank can be determined based on the eye tracking and a selection by the user. For example, the user can select the first window having the video and looking at a description of the video playing in the same first window. In such a scenario, both the eye tracking accruing a longer gaze time (than the second window) and the user selecting the first window to make it the active window can make the first window the top-ranked window.

Thus, the rank can be determined based on one or a plurality of elements. The more elements being used, the more accurate the determination of the rank. Hence, the rank can be determined by a combination of eye or gaze tracking, an input selection by a user (for example, the user clicking on an icon or a display element in a window (the first window or the second window), a user hovering a mouse or pointer over a portion of a window (without necessarily clicking or selecting anything), etc. The rank determination can also go beyond these elements/factors to include preset settings related to a particular user and/or past behavior/experiences. For example, the user can preset certain settings and/or the user's device can learn from user's past behavior/experiences about his/her preference when two or more windows are displayed at the same time side by side.

For example, this particular user may always play a video in the first window while working on a presentation in the second window. In such case, the user's device can learn from this behavior and use this knowledge to more accurately determine the rank (for example, when the first window has a video playing and the second window corresponds to a work processing document or a presentation, the active window is likely the second window). Such knowledge can be paired with eye gaze direction and other factors such as mouse/cursor movement, etc. in order to more accurately determine the rank.

In an embodiment, in step 820, the inspected main memory data can also include a reference patch therein and the first device 701 can identify the reference patch in the main memory data. In an embodiment, the first device 701 can detect and identify the reference patch in the main memory by a value, such as a known encoding, where the format of the of the data itself can indicate to the application where the reference patch is located. For example, the known encoding can be 25 bytes long and in a predetermined position within the binary bits of the main memory. In one embodiment, the first device 701 inspects the main memory data for bit data corresponding to the reference patch. For example, the bit data corresponding to the reference patch is an array of bits corresponding to pixel data making up a reference patch. In one embodiment, the presence of the reference patch is an attribute of an object or a class. In one embodiment, the reference patch is a file used by an application wherein the file is loaded into the main memory when the reference patch is displayed by the application. In one embodiment, the presence of the reference patch is indicated in metadata, e.g., with a flag. In an embodiment, the reference patch can be identified by parsing an application (e.g. a Word document), looking through the corresponding metadata in the computing memory space, and finding the reference patch in the metadata by attempting to match the metadata with a predetermined indicator indicating the presence of the reference patch, such as the unique identifier.

In step 825, the first device 701 can determine whether the software application corresponding to the computing memory space (and sub-memory space) in which the reference patch was identified is active or in the displayed data. Referring to the example of step 815, while the window of the first application can include the reference patch, the inactive window of the second application can become active and overlay over the window of the first application which was previously the active window. In such a scenario, the reference patch in the window of the first application can become covered by the window of the second application. As such, the digital content of the reference patch in the window of the first application need not be displayed or can cease being displayed. However, in an alternative scenario, the window of the first application, including the reference patch, can be active and the reference patch therein can be uncovered and visible. In one embodiment, the active window refers to the window with the most recent interaction, e.g., a click, a movement. In one embodiment, the first device 701 uses a priority list to determine which window is the active window. For example, digital content for a first application with higher priority than a second application will be displayed even if the second application covers the reference patch of the first application.

In step 830, upon determining the software application corresponding to the computing memory space (and sub-memory space) in which the reference patch was identified is active or in the displayed data, the first device 701 can decode the encoded data of the unique identifiers from the area of the reference patch, wherein the unique identifiers correspond to the surface area.

In step 835, the first device 701 can use the unique identifiers to link the surface area with the digital content using metadata and retrieve the digital content based on the unique identifiers.

In step 840, the first device 701 can overlay the digital content onto the surface area of the displayed data based on the unique identifiers.

Again, the method of identifying the reference patch included in the displayed data and augmenting the displayed data is described as performed by the first device 701, however, the networked device 750, the second client/user device 702, and/or the nth device 70n can alternatively or additionally perform the same functions.

In an embodiment, the first device 701 identifies the surface area corresponding to the reference patch by employing further processes. To this end, FIG. 4B is a flow chart of a sub-method of identifying the reference patch with the unique identifiers corresponding to the surface area from the stream of data, according to an embodiment of the present disclosure.

In step 810a, the first device 701 can decode the encoded reference patch from the main memory. The encoded reference patch can include the marker that makes up the unique identifiers within the reference patch incorporated previously. The reference patch can also include other identifying information. The marker can be disposed within the reference patch, such as within the area of the reference patch or along a perimeter of the reference patch, or alternatively, outside of the area of the reference patch.

Again, whatever schema is used to encode the marker in the reference patch is also used in reverse operation to decode the underlying information contained within the reference patch. As stated above, in an embodiment, the encoded marker can be patterns generated and decoded using the ArUco algorithm or by other algorithms that encode data according to a predetermined approach.

Similarly, as described above, in step 810b, the first device 701 can also extract attributes of the surface area from the reference patch.

Similarly, as described above, in step 810c, the first device 701 can also calculate a position and size of the surface area relative to the size and shape (dimensions) of the output signal from the display that is displaying the displayed data.

Similarly, as described above, the first device 701 can provide information regarding the characteristics of the output video signal, such that the digital content that is later overlaid can correctly be displayed to account for various manipulations or transformations that may take place due to hardware constraints, user interaction, image degradation, or application intervention. Such manipulations and transformations may be the relocation, resizing, and scaling of the reference patch and/or the surface area, although the manipulations and transformations are not limited to those enumerated herein.

Similarly, as described above, the reference patch itself can be used as the reference for which the digital content is displayed on the surface area.

Similarly, as described above, the first device 701 can determine an alternative location at which to display the digital content based on behaviors of the user.

In an embodiment, the first device 701 employs other processes to associate the unique identifiers with the digital content. To this end, FIG. 4C is a flow chart of a sub-method of associating the unique identifiers with digital content, according to an embodiment of the present disclosure. In step 820a, the first device 701 can send the unique identifiers to the second device 850 and the second device 850 can retrieve metadata that describes the digital content, the digital content being associated with the surface area through the unique identifiers. This can be done by querying a remote location, such as a database or a repository, using the unique identifiers of the surface area as the query key. In an embodiment, the first device 701 sends the unique identifiers to the second device 850 and the second device 850 associates the unique identifier of the reference patch to corresponding digital content based on the metadata. The metadata associated with the surface area's unique identifier can be transmitted to the first device 701 with the augmentation content.

In step 820b, the first device 701 can assemble the digital content that is associated with the surface area's unique identifier. The assembly can entail loading the necessary assets for assembling the digital content. In an embodiment, this can entail loading manipulation software or drivers in order to enable the first device 701 to process the digital content. Other assembling processes can be the loading of rendering information in order to transform and manipulate an individual portion of the digital content. Furthermore, the loaded manipulation software, drivers, or rendering information can be used to compile all the individual portions of the entire digital content together. In an embodiment, this can include adapting the file formats of the digital content, delaying the playback for the digital content, converting from one format to another, scaling the resolution up or down, converting the color space, etc.

In step 820c, the first device 701 can provide access control parameters for the digital content. The access control parameters can dictate whether the digital content is visible to some users, or to some geographical locations, or to some types of displays and not others, as well as the date and time or duration of time a user can access the digital content or is allowed to access. In an embodiment, visibility of the digital content can be defined for an individual. For example, the digital content can be a video that is appropriate for users over a certain age. In an embodiment, visibility of the digital content can be defined for a geographic location. For example, the digital content can be a video that is region-locked based on a location of the first device 701. In an embodiment, visibility of the digital content can be defined for a type of display displaying the displayed data. For example, the digital content can be VR-based and will only display with a VR headset. In an embodiment, visibility of the digital content can be defined for a predetermined date and a predetermined time. For example, the digital content can be a video that will only be made publicly available after a predetermined date and a predetermined time. In an embodiment, visibility of the digital content can be defined for a time period. For example, the digital content can be a video that is only available for viewing during a holiday. The first device 701 thus calculates the user's access level based on those parameters and provides an output result as to the user's ability to access the digital content, i.e., whether the digital content will be visible or invisible to the user. Note that the access control parameters can be global, for all the displayed data, or it can be localized per surface area and the underlying digital content.

Referring again to FIG. 4A, in step 840, the first device 701 can carry on the processes of overlaying the surface area with the digital content into the displayed data in accordance with the surface area, the position, and the size identified by the unique identifier. The first device 701 can determine or adjust the size and location of the assembled digital content on the surface area relative to the size and shape of the displayed data being outputted by the display. Then, the first device 701 can render the associated digital content (or the assembled individual portions) over the surface area's shape and perimeter using the size and location information. Thus, the digital content is superimposed on top of the surface area.

The first device 701 can continuously monitor changes that are taking place at the end user's device (such as the networked device 750 of the second user) to determine whether the reference patch and/or the surface area has moved or been transformed in any way (see below for additional description). Thus, the first device 701 can continuously inspect subsequent frames of the stream of the data (for example, every 1 ms or by reviewing every new frame), displaying the displayed data, to determine these changes. The first device 701 can further continuously decode the reference patch's data from the identified reference patch. Then the first device 701 can continuously extract attributes from the data, the attributes being of size, shape, and perimeter and comparing those changes between the current frame and last frame. Further, the first device 701 can continuously calculate the size and location of the surface area and compare changes between the size and location of the surface area from the current and the last frame and then continuously overlay the digital content on the surface area by incorporating the changes in the reference patch's attributes and the changes in the size and location of the surface area. As stated above, when the user manipulates his/her display device by scaling, rotating, resizing or even shifting the views from one display device and onto another display device, the first device 701 can track these changes and ensure that the digital content is properly being superimposed onto the surface area.

In an embodiment, the methodologies discussed with reference to FIG. 3 that use the frame buffer can be used without using the methodologies discussed with reference to FIG. 4 that use the memory space and vice-versa. In other words, in an embodiment, either the methodologies of FIG. 3 or the methodologies of FIG. 4 can be used to identifying a reference patch and overlay the digital content in displayed data.

However, in an embodiment, both the methodologies discussed with reference to FIG. 3 that use the frame buffer and the methodologies discussed with reference to FIG. 4 that use the memory space can be used together. In such embodiment, a device can use both approaches to accurately identify the same reference patch (applying both approaches can yield better results). In an embodiment, both approaches can be used to identify different reference patches. For example, if a document includes a plurality of reference patches, the first device can apply the methodologies discussed with reference to FIG. 3 to a first reference patch, while applying the methodologies discussed with reference to FIG. 4 to a second reference patch.

An illustrative example will now be discussed: a scenario where a user (for example, a user at the first device 701) receives (from another device such as the second client/user device 702) an email with the embedded reference patch in the body of the email or as an attached document. The reference patch within the displayed data (email) can show a facade of the digital content or the reference patch. The application on the first device 701 can scan the display to find the reference patch and the surface area and the attributes within the displayed data as it is being displayed. Furthermore, the first device 701 can access the digital content using the unique identifier and metadata and prepare it for overlaying. At which point, the user (i.e., the recipient) can select the digital content by various ways such as by clicking on the digital content's facade or the surface area, or otherwise indicating that it intends to access the digital content.

Thereafter, the digital content can be retrieved from the networked device 750 using the unique identifier and the metadata saved within a database that directs the networked device 750 to where the digital content is saved and can be obtained. That is, the networked device 750 can determine the digital content corresponding to the derived unique identifier and send the digital content corresponding to the unique identifier (and the metadata) to the first device 701. Then, the first device 701 can superimpose (overlay) the digital content on the surface area. While the digital content is being received and overlayed on the surface area, the first device 701 can continually monitor the location, size and/or shape of the reference patch and/or the surface area to determine movement and transformation of the reference patch and/or the surface area. If the user has moved the location of the reference patch and/or the surface area, or has resized or manipulated the screen for whatever purpose, the new location, shape and/or size information of the reference patch and/or the surface area is determined in order to display the digital content properly within the bounds of the surface area. Thus, the digital content moves with the displayed data as the displayed data is moved or resized or manipulated.

In an embodiment, a user that has received the displayed data embedded with the reference patch can access the digital content on his/her first device 701, as described above. The user may want to transfer the ongoing augmenting experience from the first device 701 to another device, such as the device 70n, in a seamless fashion. In that scenario, the user is able to continue the augmenting experience on his/her smartphone, smartwatch, laptop computer, display connected with a webcam, and/or tablet pc. The user therefore can capture the embedded reference patch and therefore the encoded attributes, as the digital content is being accessed and overlaid unto the surface area. The user can capture the embedded reference patch by taking a picture of it or acquiring the visual information using a camera of the second client/user device 702 as mentioned above. The user can capture the embedded reference patch by accessing the main memory of the second client/user device 702 as mentioned above.

Assuming the user also has the functionality included or the application installed or running on the device 70n, the device 70n would recognize that an embedded reference patch and encoded unique identifiers are in the captured image/video stream or in the main memory of the device 70n, such as in the corresponding computing memory space as the software application currently active on the device 70n. Once the surface area has been determined and the reference patch decoded, the digital content can be obtained from the networked device 750, using the unique identifiers and the metadata and then overlaid on the surface area within the displayed data displayed on the device 70n. In an embodiment, as soon as the device 70n superimposes the digital content onto the surface area, the networked device 750 or the backend determines that the stream has now been redirected onto the device 70n and thus pushes a signal to the first device 701 to stop playing the digital content on the first device 701. The device 70n that is overlaying the digital content therefore resumes the overlaying at the very same point that the first device 701 stopped overlaying the digital content (for instance, when the content is a video). Thus, the user is able to handoff the digital content from one device to another without noticing delay or disruption in the augmenting experience.

In one embodiment, the visibility of the digital content is dynamic and can be adjusted. For example, in one context an augmentation overlaps with another image and obscures the image by being displayed in front of the image. At a later time, the augmentation is displayed behind the image such that the image obscures the augmentation when the augmentation is no longer needed. In one embodiment, the transparency of an augmentation can be adjusted to show objects in the same location as the augmentation. In one embodiment, the interactive properties of digital content are also dynamic and can be modified. Click-ability refers to whether an object can be clicked or otherwise activated by a trigger, thus causing an action to be performed. The action includes, but is not limited to, sending data, receiving data, and/or modifying display content. When the click-ability of an object is on, the trigger causes the action to be performed. When click-ability of an object is off, the trigger does not cause the action to be performed. Touch-ability is a subset of click-ability wherein the trigger is a touch using a touch panel. The trigger can be collected by an input device, including, but not limited to, a mouse, a keyboard, a touch panel, a camera, and/or a microphone.

The click-ability of any augmentation layer and/or object of digital content can be modified. In one embodiment, the click-ability of an object in a layer can be modified independently of other objects in that layer. For example, only one button is active (clickable) while other buttons in the augmentation are not active. In addition, objects in different layers can simultaneously be clickable. For example, the original displayed data is a slide deck wherein a slide in the slide deck includes a button for proceeding to a next slide. The slide includes a reference patch, and an electronic device identifies the reference patch and displays an augmentation including a multiple-choice survey. The answers to the multiple-choice survey and the button for proceeding to the next slide are all clickable, enabling a user to interact with the augmentation as well as the original displayed data. In another embodiment, the button for proceeding to the next slide is not clickable until an answer to the multiple-choice survey has been collected. Thus, inputs and interactions on one layer can be used to affect another layer. In one embodiment, transparency and click-ability can be adjusted at a pixel level. For example, if an object is partially obscured, only the visible part of the object is clickable.

In one embodiment, click-ability and transparency can be connected. For example, a first clickable object in a first layer and a second clickable object in a second layer are located on the same surface area of a display. The click-ability of the first clickable object is on and the click-ability of the second clickable object is off for a period of time. During this period of time, the second clickable object is transparent (or semi-transparent) and only the first clickable object is visible on the display. After the period of time elapses, the click-ability of the first clickable object is turned off, while the click-ability of the second clickable object is turned on. Accordingly, the first clickable object is then transparent while the second clickable object is not transparent. The transparency and click-ability of the objects can be set independently of the order in which layers are created, edited, retrieved, and/or displayed. In another example, an electronic device displays a full-screen Microsoft PowerPoint® presentation and full-screen scrolling speaker's notes at the same time in one window, wherein the click-ability of any of the pixels of the presentation and the notes can be adjusted to be on or off. The result is a multi-layered content stack experience wherein attributes such as transparency and click-ability for any layer in the stack can be adjusted at the pixel level.

In one embodiment, pixels in one layer can have click-ability on, while pixels in the remaining layers can have click-ability off. Further, portions of pixels within layers that have click-ability off can have their click-ability turned on, while the remaining pixels in that layer remain off (and vice versa). The determination of which pixels have click-ability on and off can be determined based on parameters including, but not limited to, user settings, hot spots, application settings, user input. Hot spots can refer to regions of a computer program, executed by circuitry of a device, where a high percentage of the computer program's instructions occur and/or where the computer program spends a lot of time executing its instructions. Examples of hot spots can include play/pause buttons on movies, charts on presentations, specific text in documents, et cetera.

Referring back to the displayed data discussed above, in an example, the displayed data can be a page of a website. The webpage may be dedicated to discussions of strategy in fantasy football, a popular online sports game where users manage their own rosters of football players and points are awarded to each team based on individual performances from each football player on the team. After reading the discussion on the website page, the reader may wish to update his/her roster of football players. Traditionally, the reader would be required to open a new window and/or a new tab and then navigate to his/her respective fantasy football platform, to his/her team, and only then may the reader be able to modify his/her team. Such a digital user experience is cumbersome and inefficient. With augmentation, however, the reader may not need to leave the original webpage as a reference patch corresponding to a fantasy football augmentation may be positioned within the viewable area of the website page. The corresponding augmentation may be, for instance, an interactive window provided by a third-party fantasy football platform that allows the reader to modify his/her roster without leaving the original website. Thus, instead of navigating to a different website and losing view of the informative fantasy football discussion, the reader can simply interact with the digital object of the augmentation in the current frame of displayed data because of the presence of the reference patch.

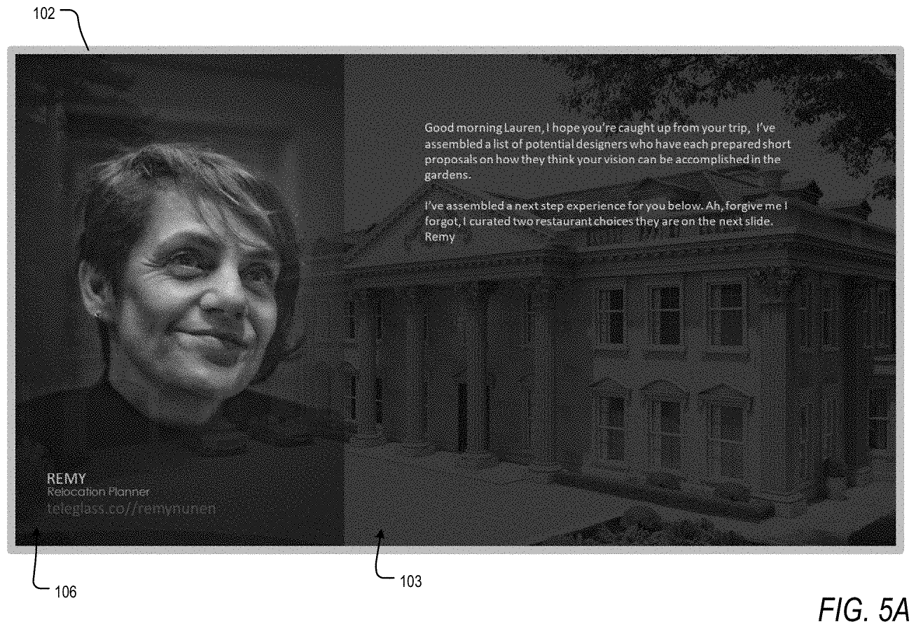

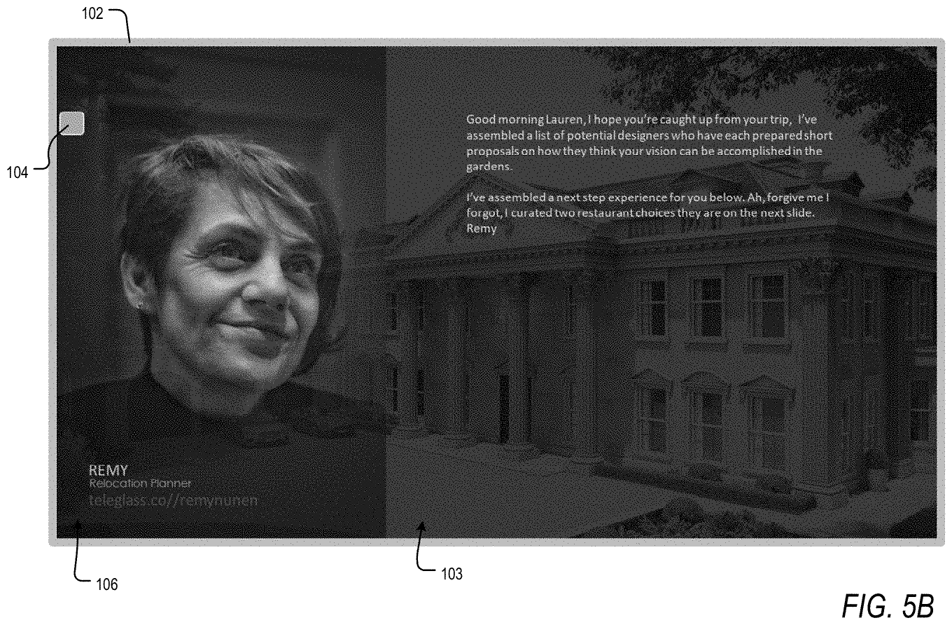

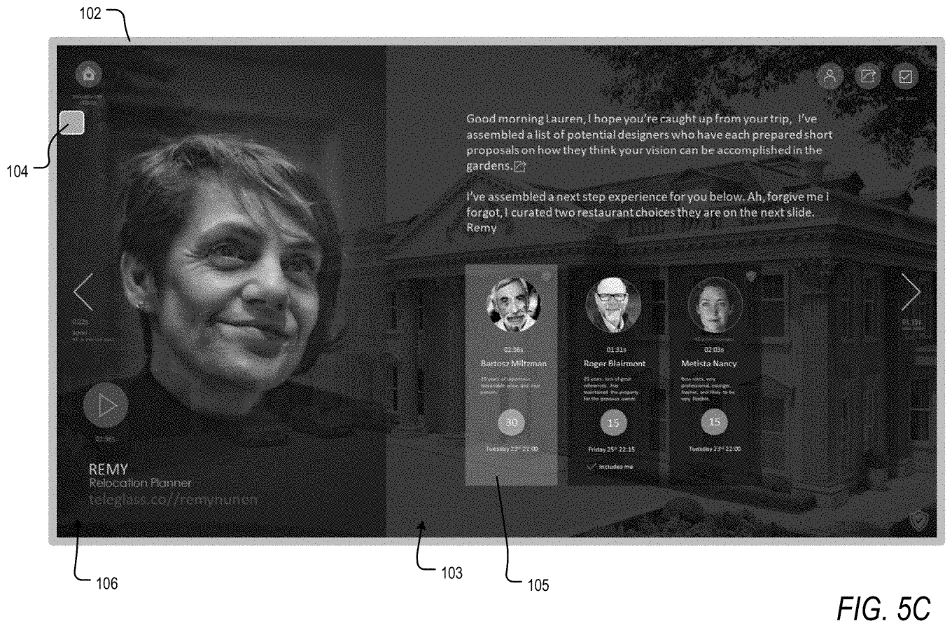

In another example, as will be described with reference to FIG. 5A through FIG. 5C, the displayed data can be a slide deck. The slide deck may be generated by a concierge-type service that seeks to connect a client with potential garden designers. As in FIG. 5A, the slide deck may be presented to the client within a viewable area 103 of a display 102. The presently viewable content of the slide deck within the viewable area 103 of the display 102 may be a current frame 106 of displayed data. Traditionally, the slide deck may include information regarding each potential garden designer and may direct the client to third-party software applications that allow the client to contact each designer. In other words, in order to connect with one or more of the potential garden designers, the client, traditionally, may need to exit the presentation and navigate to a separate internet web browser in order to learn more about the garden designers and connect with them. Such a digital user experience is cumbersome and inefficient. With augmentation, however, the client need not leave the presentation in order to set up connections with the garden designers. For instance, as shown in FIG. 5B, a reference patch 104 can be positioned within the slide deck so as to be in the current frame 106 and viewable within the viewable area 103 of the display 102 at an appropriate moment. As shown in FIG. 5C, the reference patch 104 may correspond to one or more augmentations 105 and, when the reference patch 104 is visible, the augmentations 105 are displayed and brought to life. The one or more augmentations 105 can include, as shown in FIG. 5C, interactive buttons, images, videos, windows, and icons, among others, that allow the client to interact with the secondary digital content and to, for instance, engage with the garden designers without leaving the presentation. In an example, the interactive augmentations 105 may allow for scheduling an appointment with a given garden designer while still within the slide deck. In one embodiment, the augmentations are only presented when the reference patch is included in the displayed data. In one embodiment, the reference patch identifies the digital content of the augmentation. The digital content of the augmentations is visually integrated into the displayed data.

The above-described augmentations are particularly relevant to environments where the underlying content is static. Static content may include textual documents or slide decks. Often, the static content is stored locally. A result of the static content is static augmentations that are not capable of dynamically adjusting to or being adjusted dynamically according to complex user interactions, in real-time, during a user experience. The addition of dynamic augmentations improves user experience by providing additional data and personalized, interactive elements.

Such a dynamic environment includes one where, for instance, a video conversation is occurring. A first participant of the video conversation may share his/her screen with a second participant of the video conversation and wish to remotely control an augmentation on a display of a device of the second participant. By including a reference patch within the displayed data that is being ‘shared’, which may be the video itself or another digital item, where sharing the displayed data includes transmitting the displayed data over a communication network from the first participant to the second participant, the second participant may be able to experience the augmentation when the device of the second participant receives the transmitted displayed data and processes it for display to the user.

Generally, and as introduced in the above example of a dynamic environment, a reference patch can be inserted into displayed data displayed on a first computer. The display of the first computer can be streamed to a second computer. In an example, the second computer decodes the streamed display and identifies the reference patch in the displayed data. Based on the identified presence of the reference patch, the second computer can locally augment the display of the second computer to overlay the intended augmentation on the ‘streamed’ display from the first computer. The design and the arrangement of the augmentation can be provided relative to the reference patch placed into the displayed data on the first computer. The augmentation can include a number of objects to be displayed and may be configured to display different subsets of objects based on interactions of a user with the augmentation. The objects, therefore, can be interactive. In one embodiment, the second computer can retrieve the augmentation from a server. Thus, the augmentation is not included directly in the displayed data streamed from the first computer to the second computer but is retrieved and included in the display at a later time. In one embodiment, the unique identifier included in the reference patch provides further information and/or instructions for retrieving the augmentation.

In one embodiment, an electronic device such as the first device 701 can render and display image data with adjustable regional transparency and click-ability. The image data can include the displayed data and/or the digital content. In one embodiment, the displayed data and/or digital content can include a video represented by video data, wherein the video data can include an alpha channel for storing transparency data for each pixel. The video data can be transmitted in or converted to a format that supports the alpha channel. The video can be displayed, e.g., by a video player, wherein the transparency of each pixel in the video can be adjusted according to a desired composite image. The composite image can include all visible data (e.g., image data) displayed by the first device 701. The composite image can be a combination of image data from various applications, programs, sources, and/or windows displayed by the first device 701. For example, the composite image can include a slide deck with a video of a presenter overlayed on the slide deck. The slide deck can be displayed by a presentation software, while the video can be displayed by a video player program. As another non-limiting example, the composite image can include a text document with an image file overlayed on the text document. In one embodiment, the regional transparency of any image or window in the composite image can be adjusted by the first device 701. When a first image or window in the composite image is transparent, a second image or window present behind the transparent (or semi-transparent) region can be visible through the transparent region. In one embodiment, the first device 701 can create the composite image after inspecting the main memory to determine visible image data from each window, application, and/or image stored in the main memory. The first device 701 can then load the composite image into the frame buffer for display.

In one embodiment, the transparency of each pixel can be adjusted, for example, along a gradient between completely transparent and completely opaque. For example, an alpha channel value of 128 in an 8-bit system for a pixel can correspond to the pixel being displayed with a transparency approximately halfway between fully transparent and fully opaque. The resulting pixel will include a combination of image data from multiple sources. In one embodiment, the combination can be a weighted average of image data at that pixel location from multiple sources, wherein the weights correspond to the transparency of each pixel at that pixel location. The bit depth of the alpha channel and the individual pixel adjustment can enable regional transparency of the image data in the present invention. For example, certain regions of a video can be made transparent, while other regions are opaque. The video can then be overlayed onto displayed data and/or digital content for a seamless visual experience, wherein the video and the displayed data and/or digital content appear visually integrated into a single layer in the composite image.

In typical video players, the display of a video is confined to data loaded into the video player. If a portion of the video is transparent, only a background image stored or set in the video player (e.g., a default background or a blank screen) will be visible through the transparent portion. The transparency of the video does not provide functional or visual benefit because the video is not integrated into image data that is external to the video player. In one embodiment of the present invention, the video can be played by a video player on an electronic device (e.g., the first device 701) wherein image data that is external to the video player can be visible through transparent portions of the video. The video player can thus achieve full transparency of the video that is being played. For example, the video can be overlayed on top of displayed data such that both the video and the displayed data appear as if they are displayed in the same window. As another example, a video is being played by a first application, e.g., a video player. A second application, e.g., a word processing software, is open on the same device, wherein the second application displays a text document. The video player is displayed in front of the word processing software. The text document is visible through transparent regions of the video being played by the video player. The video is fully integrated into all of the displayed data rather than being confined to the video player. Thus, the video can be used to highlight areas of the text document in a dynamic manner. The same effect can be applied if the first application displays a static image given that video data is made up of static frames.

In another example embodiment, the image data can include a first video feed and a second video feed. The two video feeds can be overlayed with regional transparency, wherein transparency in the second video feed results in the first video feed being visible in place of the transparent (or semi-transparent) region of the second video feed. The overlayed data can include different file formats and/or different applications.

In one embodiment, the integration of the transparent video with the displayed data and/or the digital content can be accomplished by inspecting main memory, as described above. An electronic device such as the first device 701 can inspect the main memory of the first device 701 to identify what is being displayed by each application, program, or window open on the first device 701. The first device 701 can then determine which pixels in the displayed data and/or the digital content are transparent as defined in the alpha channel. The first device 701 can merge or replace transparent pixels displayed by a first application with non-transparent pixels from applications or windows that occupy the same location on the display as the transparent pixels. The non-transparent pixels from the applications or windows can then be visible in place of the transparent pixels.

In one embodiment, the first device 701 can aggregate memory spaces from the main memory into an array. The array can include information regarding software applications running on the first device 701. The array can include image data meant for display by each of the applications, as well as the location parameters of the image data, wherein the location parameters can be expressed as a pixel coordinate (e.g., a center pixel) and a size (e.g., a window height and a window width). The first device 701 can inspect the memory spaces in the array to determine the visibility of each pixel for each application in order to create the composite image. For example, in a typical display, if there is an overlap between a top application and a bottom application without transparency, the first device 701 can use the data in the array to display a top application in the region of the overlap instead of a bottom application. In the present invention, if the region of overlap in the top application is transparent, the first device 701 can display the bottom application in the transparent region of the top application instead of the top application. In one embodiment, the image data can be translucent or partially transparent rather than fully transparent. The first device 701 can combine partially transparent image data with underlying image data so that both are visible, with the partially transparent image data partially obscuring the underlying image data.

In one embodiment, the first device 701 can inspect the frame buffer and use computer vision (as described above) to identify a transparent region in a frame of image data. The first device 701 can identify a location, a shape, and/or a size of the transparent region using computer vision. The first device 701 can then determine what to display in place of the transparent region. The transparent region can be a first region within a first frame of image data. The first device 701 can identify a second region, or a substitute region, to display with the transparent region. The first region and the second region can correspond to each other, e.g., have a shared characteristic. In one embodiment, the first region and the second region can be in approximately the same location in their respective frames, or the second region can be in a like location to a location of the first region. For example, the first region can be located in the top left corner of the first frame when the first frame is displayed. The second region can also be located in the top left corner of the second frame when the second frame is displayed. The location of the first region and the location of the second region can be the same or can be within a certain range of each other. In one embodiment, the first device 701 can access the main memory to determine image data from windows, applications, or programs in a substitute region at the same or like location as the transparent region in order to create the composite image. The like location can refer to a location that is the same as, similar to, encompassing, or within the location of the transparent region. In another embodiment, the first device 701 can load image data into the frame buffer and inspect the frame buffer to determine the image data in a substitute region at the same location as the transparent region. In one embodiment, the image data that is visible through the transparent region can be image data from the OS of the device.

In some embodiments, the first region and/or the second region can be transparent or partially transparent. For example, the first region can be a partially transparent region in the first frame. A partially transparent region can be displayed such that a substitute region that corresponds to the partially transparent region is visible. For example, the substitute region can be a region at the same location as the partially transparent region, as described above. It can be appreciated that the example of a first frame and a second frame, and a first region and a second region, is non-limiting and that the methods disclosed herein can be applied to any number of frames and regions of image data.

In one embodiment, the transparency of each frame of the image data can be adjusted by the first device 701 over time, e.g., in real time or near real time. For example, the first device 701 can display a dynamic image or a video, such as a live broadcast, and the transparency of additional data overlayed on the live broadcast can be adjusted based on what is being displayed on the live broadcast. The additional data overlayed on the live broadcast can be a transparent region, and the region of the live broadcast corresponding to the additional data (e.g., in the same location as the additional data) can be a substitute region. In another non-limiting example, the first device 701 can display a slideshow, and the transparency of the additional data be adjusted based on the content of each slide in the slideshow. In one embodiment, the additional data can be digital content retrieved based on a reference patch. In another embodiment, the additional data can be displayed data stored in the memory of the first device 701.

In one embodiment, the first device 701 can be configured to detect objects and/or features in the image data and adjust the transparency of the image data accordingly. In one embodiment, the first device 701 can use computer vision (as described above) to identify objects in the image data. In another embodiment, the first device 701 can inspect the main memory of the first device 701 (as described above) to identify the objects in the image data. In one embodiment, the first device 701 can identify overlap between objects in the image data and automatically adjust the transparency of the objects accordingly. For example, the first device 701 can display digital content overlayed on displayed data such that any background regions in the digital content, or regions without objects, are transparent, and the displayed data is visible in place of the transparent regions. A background region of the digital content can be a transparent region in the first frame, and the substitute region in the second frame can be a region including the displayed data that is visible in place of the transparent region.

In one embodiment, the first device 701 can adjust the transparency of the image data based on a prioritization of objects. It can be desired that certain objects are always visible. For example, a reference patch in displayed data needs to be visible in order for the first device 701 to incorporate corresponding digital content. A first device 701 can adjust the transparency of the digital content such that any region of the digital content that overlaps with the reference patch is transparent. In another example, an object in digital content, such as an interactive button, should always be visible when the digital content is visible. The first device 701 can adjust the transparency of the digital content such that the region where the interactive button is located is always opaque, even if the location of the button changes. In one embodiment, information about the visibility of the objects can be stored in the memory of the first device 701. In another embodiment, information about visibility of the objects can be transmitted to the first device 701, e.g., from a networked device 750. In yet another embodiment, the first device 701 can determine the visibility of the objects automatically based on object recognition as described herein.

In one embodiment, the first device 701 can use metadata to determine the transparency of the image data. For example, the first device 701 can receive a description of the image data. The description of the image data can be stored in memory. The description can include information about where objects in the image data are located, e.g., pixel coordinates, relative locations. In one embodiment, the image data can be dynamic, e.g., a video, and the description can further include timestamped information about the locations of the objects in the image data. The first device 701 can then adjust the transparency of the image data over time based on the description. For example, the first device 701 can display a video of a moving object. Digital content can be used to highlight the moving object when it is in a certain region. The digital content is transparent when the moving object is not in the region and visible when the moving object is in the region. The transparency of the digital content can be adjusted based on the location of the moving object, which can be included in the description of the video.

In one embodiment, the first device 701 can receive the image data, e.g., digital content, from a networked device 750, such as a server. The networked device 750 can determine the transparency of the digital content. In one embodiment, the networked device 750 can adjust the transparency of the digital content based on information received from the first device 701. For example, data encoded in the reference patch such as the unique identifiers and corresponding metadata can indicate transparency of regions of the digital content. As another non-limiting example, the networked device 750 can receive information from the first device 701 about the displayed data and use the information about the displayed data to adjust the transparency of the digital content. In another embodiment, the networked device 750 can identify objects in the digital content and/or the displayed data and adjust the transparency of regions in the digital content based on the identified objects. Thus, the alpha channel of the digital content can be modified by the networked device 750 and does not have to be modified by the first device 701. In one embodiment, the networked device 750 can adjust the transparency of the digital content in real time or near real time.

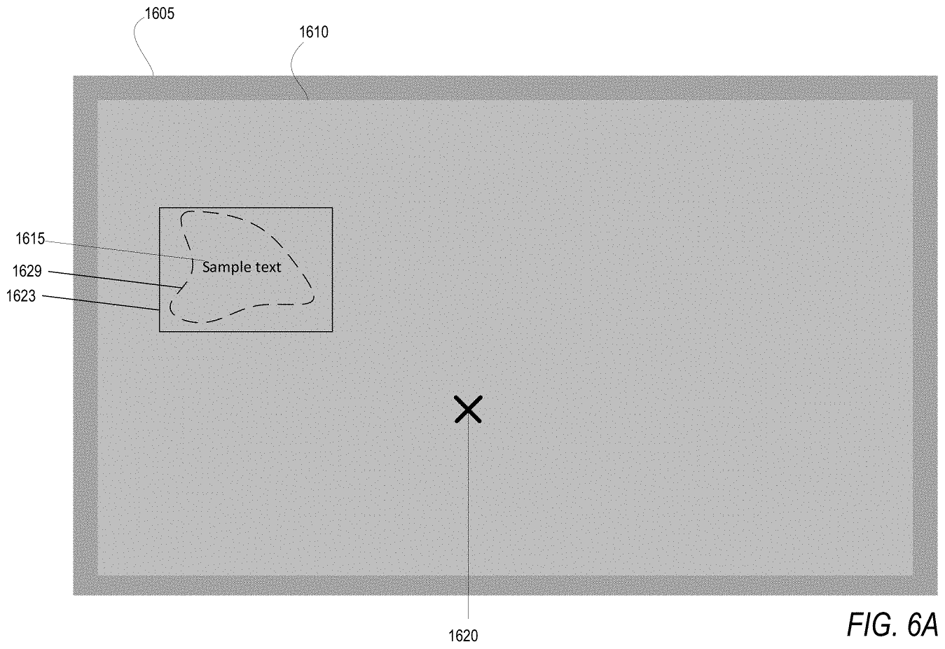

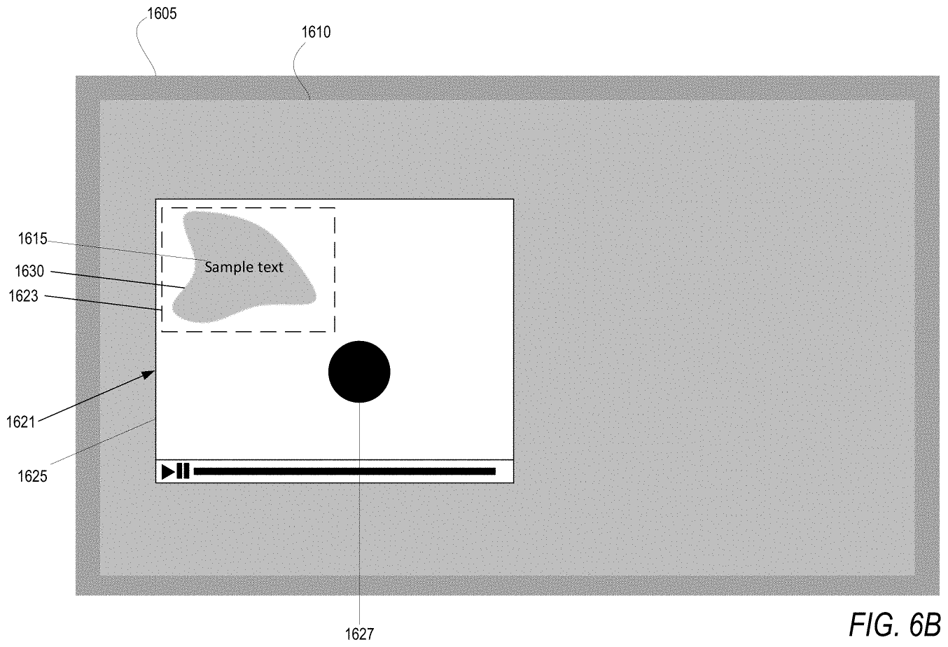

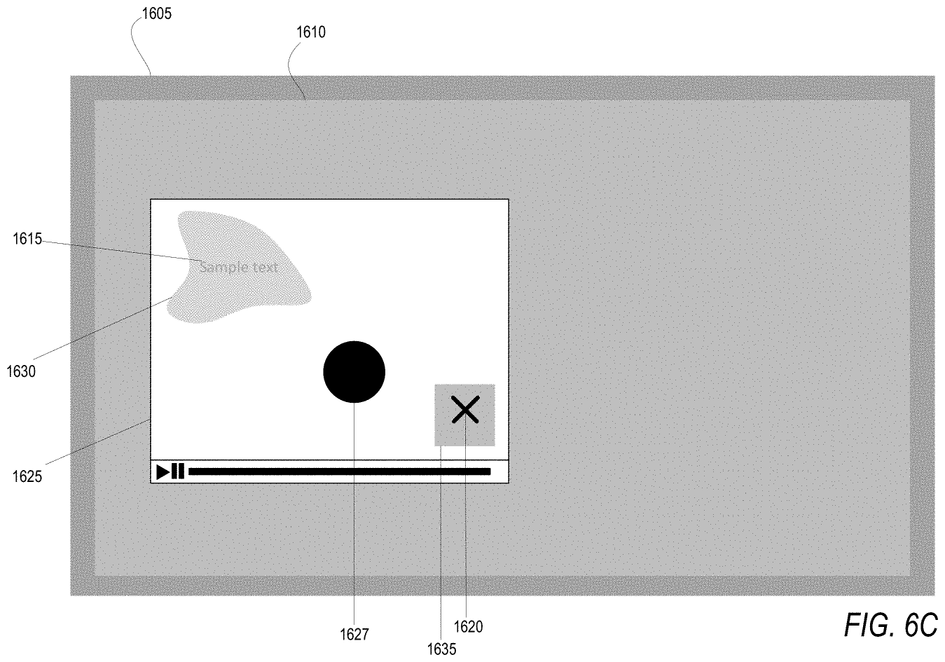

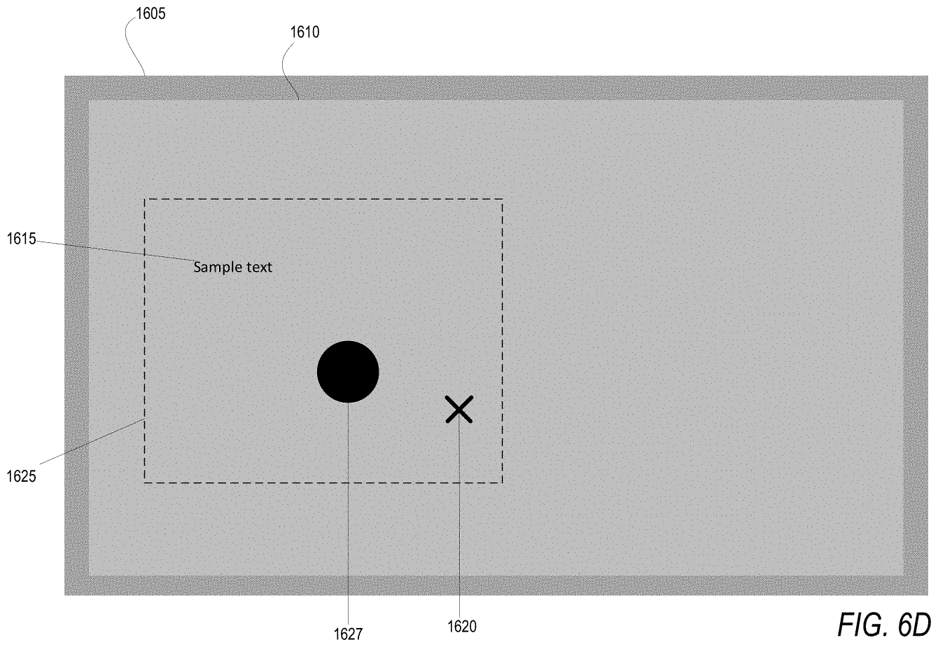

FIG. 6A illustrates an example of a viewable area 1610 of a display 1605 of a first device 701 according to one embodiment of the present invention. The viewable area 1610 can include, for example, a slide 1623 from a slide deck containing text 1615. The viewable area 1610 can further include an image 1620. FIG. 6B illustrates the viewable area 1610 of the display 1605 to further include an example of a video 1625 being presented in the viewable area 1610 where the video 1625 is shown overlayed on top of the slide 1623. The video 1625 can include a video object 1627 and a transparent region 1630. The transparent region 1630 can be located anywhere in the video 1625. In the interest of simplicity of illustration, in FIG. 6B, the transparent region 1630 is shown as a region overlayed on top of the text 1615, i.e., a portion of the slide 1623. Due to the transparency of the overlay, the text 1615 in the slide 1623 is visible through the transparent region 1630 of the video 1625. In some embodiments, the transparent region 1630 may be overlaid onto the entirety of the slide 1623.

In some embodiments, the transparency of the transparent region 1630 may be modified, i.e., the region may be made more or less opaque as desired. Various types of input to the first device 701 may cause such transparency modification. For example, transparency of the transparent region 1630 may be modified in response to the first device 701 receiving a keyboard input, a mouse input, or a recognized gesture. The size and shape of the transparent region 1630 may be modified as desired. The size may be adjusted to emphasize or de-emphasize certain content, for design reasons, or for cost measures. The size and/or the location of the transparent region may be based on the stream of image data that includes the substitute region. For example, the size and/or the location of the transparent region 1630 in FIG. 6B may be based on the slide 1623 of FIG. 6A. Obviously, if the transparent region is intended to make visible the text 1615, the size of the transparent region 1630 cannot be larger than the size of the slide 1623 and the location of the transparent region 1630 has to overlap with the location of the text 1615.

As discussed in further detail herein, the content in the transparent region may be transmitted to remote sites with a different file format than, for example, the remaining regions of the content. To this end, the file format may be reflective of the desired quality of the content. For example, content that is to be emphasized or somehow more visible or prioritized may be transmitted with lossless compression whereas the remaining portions of the content (content outside of the transparent region) may be transmitted using lossy compression techniques. That is, assuming FIG. 6B illustrates a second frame and FIG. 6A illustrates a first frame, the text 1615 may be transmitted using a lossless compression format for a higher quality effect of the text 1615 whereas the remaining portions of the video 1625 may be transmitted using lossy compression format because a relatively lower quality can be tolerated. Such a scenario may be useful in emphasizing or highlighting content, in this case the text 1615, in the transparent region 1630, for example. Though use of lossless compression techniques may lead to an increase in file size—at times undesirable—selective use of lossless compression can result in files that are still manageable while maintaining high-quality content, especially for select images or regions of content.

Generally, the greater the compression, the smaller the file size. Lossy methods provide high degrees of compression and result in smaller compressed files relative to lossless compression, which can result in some number of the original pixels, sound waves, or video frames can be permanently removed. Examples of lossy compression formats are JPEG, MPEG, and MP3. On the other hand, lossless compression is a class of data compression algorithms that allows the original data to be perfectly reconstructed from the compressed data. Lossless compression methods are reversible, examples of which are ZIP and PNG.

In an embodiment, the video 1625 in FIG. 6B can be a part of a first frame and the slide 1623 and therefore the text 1615 can be part of a second frame. The first device 701 or the networked device 750 can identify the transparent region 1630 in the first frame, identify at least one substitute region, e.g., substitute region 1629, in the second frame, where the substitute region 1629 is located, in the second frame, at a like location to the location of the transparent region 1630 in the first frame. The first device 701 or the networked device 750 can overlay the video 1625 onto the slide 1623 and image 1620 to generate a composite image 1621 shown in FIG. 6B. The composite image 1621 includes the video 1625 and the video object 1627 with the substitute region 1629 displayed in the location of the transparent region 1630. Overlaying of the video 1625 with the transparency region 1630 effectively acts as a filter or mask covering all regions of the viewable area 1610, as outlined by the shape of the video 1625, including the image 1620, other than the transparency region 1630, and exposing the region of the viewable area 1610 (substitute region 1629) that is covered by the transparency region 1630.

In one embodiment, the video 1625 and the slide 1623 can be displayed by two different applications, such as a video player and a presentation software, respectively. The text 1615 from the presentation software can be visible through the transparent region 1630 of the video 1625 because the video player does not have a static background and is, at least in part, transparent instead.

In one embodiment, the first device 701 can inspect the main memory of the first device 701 to determine the location of the transparent region 1630 in the video 1625. The first device 701 can then inspect the main memory to determine the image content of the slide in the location of the transparent region 1630. The first device 701 can then load the image of the text 1615 into the frame buffer of the first device 701 along with the video 1625 to achieve functional transparency in the video 1625. In another embodiment, the first device 701 can receive instructions to display the text 1615 in the slide. The first device 701 can inspect the main memory to determine the location of the text 1615 in order to create the transparent region 1630 in an overlapping location (substitute location 1629) between the video 1625 and the text 1615. In another embodiment, the first device 701 can use computer vision to identify the location of the text 1615 before the video 1625 is displayed and create the transparent region 1630 in the overlapping location of the video 1625.

In one embodiment, the first device 701 can adjust the transparency of the image data based on interactions with the first device 701. For example, a region of the image data can be clickable. Triggers and/or gestures (e.g., a click, a touch, a swipe) can adjust the transparency of a region. A click or similar trigger (e.g., a touch) applied to the region can result in the region becoming transparent. Another trigger can result in a transparent region becoming opaque. The click-ability of the image data can be adjusted on a pixel level. The first device 701 can control which regions of the image data can be triggered by external input to adjust transparency. In one embodiment, transparency and click-ability can be related properties. The first device 701 can turn off click-ability of a transparent pixel. In another embodiment, transparency and click-ability can be unrelated properties. A transparent pixel can be clickable, or an opaque pixel can be unclickable. In an example embodiment, the click-ability of a pixel can be linked to an image. For example, a region of a first image can be clickable. When the region of the first image becomes transparent (e.g., as a result of a click), a substitute region of an underlying image at the same location is visible. The click-ability of the substitute region in the underlying image can be turned off so that the underlying image is not clickable. Therefore, a click at the location will result in the region of the first image becoming visible rather than adjusting the transparency of the substitute region in the underlying image.

FIG. 6C illustrates an example of the viewable area 1610 of the display 1605 wherein regional transparency can be adjusted via user interaction. The video 1625 can be overlayed onto the viewable area 1610. In one embodiment, transparency of the video 1625 be adjusted with a trigger, e.g., a touch. For example, clicking the transparent region 1630 can adjust the transparent region 1630 to be partially transparent rather than fully transparent. In one embodiment, a second transparent region 1635 can be created in the video 1625 as a result of a trigger (e.g., a click) at the location of the second transparent region 1635. The image 1620 on the slide can be visible through the second transparent region 1635 in the video 1625. In one embodiment, the size and shape of the second transparent region 1635 can be set by the first device 701 so that the full image 1620 is visible. In one embodiment, the first device 701 can use computer vision (e.g., image recognition) to verify that the full image 1620 is visible through the second transparent region 1635. In one embodiment, the clickability of the image 1620 can be adjusted when the second transparent region 1635 is created. For example, the image 1620 can be a button wherein the button is only clickable when the image 1620 is visible. The transparent regions of the video 1625 can be created and modified independently and with varying degrees of transparency.

In one embodiment, additional regions of the video 1625 can be rendered transparent by the first device 701, as illustrated in FIG. 6D. For example, the video object 1627 can be relevant to the slide on the viewable area 1610, while the remaining background of the video 1625 is not needed. The first device 701 can set the background regions of the video 1625 to be transparent so that only the video object 1627 is visible from the video 1625. The background regions of the video 1625 can include, for example, the outline of the video player and media control buttons of the video player. In one embodiment, the media control buttons are not included in the video player, e.g., if the video 1625 is a livestream. In one embodiment, the first device 701 can use computer vision (e.g., object recognition) to identify the video object 1627 and the background. In one embodiment, the video object 1627 can remain opaque and the background regions remain transparent even if the video object 1627 moves within the video 1625. In one embodiment, the transparency of the background regions can be set using user input. For example, a trigger registered by the first device 701 (e.g., a click) on the background region can result in the background regions of the video 1625 becoming transparent. The video object 1627 can appear integrated into the slide of the viewable area 1610 while still being displayed by the video player.

In one embodiment, regional transparency can be used to modify an image quality of a composite image. In an example embodiment, the composite image can include a first image layer overlayed on a second image layer. The first image layer can include a video, and the second image layer can include a static image. The content of the first image layer and the second image layer are not limited to images but can include other applications or data types (e.g., text) for display. In one embodiment, the first device 701 can modify the first image layer and the second image layer to create a composite image effect. For example, a first region of the first image layer can be visible through a transparent or partially transparent region of the second image layer. The first device 701 can modify the first region of the first image layer while maintaining the second image layer. The first region is not limited to a region of the screen but can include the entire first image layer.

In one embodiment, modifications can include, but are not limited to, modifying pixel values, modifying pixel locations, modifying a contrast, a saturation, a brightness, a clarity, and/or other visual characteristics of a region, and/or applying a filter to the region. For example, the first device 701 can increase a contrast of the first region so that the first region stands out in the composite image. As another, non-limiting example, the first device 701 can enhance the quality of the first region, e.g., by interpolating pixels to increase the image resolution of the first region. The first device 701 can thus create a high-definition (HD) composite image. Modifying the first image layer can improve the quality of the composite image and achieve a desired effect that could not be accomplished by displaying the first image layer or the second image layer alone or merely in combination without modification. In one embodiment, the first device 701 can modify both the first image layer and the second image layer to create the composite image. For example, the first device 701 can increase a contrast of the first region of the first image layer and decrease the contrast of a second region of the second image layer surrounding the first region in order to further highlight the first region. The modifications to the composite image can be applied to any layer in a plurality of layers. Advantageously, the composite image can be created by a single application or program on the first device 701 even if each image layer in the composite image includes image data from different applications, programs, and/or windows.

In one embodiment, the composite image can be automatically created and modified by the first device 701 using intelligent rendering. In one embodiment, the composite image can be modified in real time or near real time. The first device 701 can identify (e.g., using computer vision, by inspecting the main memory of the first device 701) the content of the composite image and modify any of the image layers in the composite image in order to achieve a desired effect. The first device 701 can also identify content that is not visible in any of the image layers. In one embodiment, the content can be modified based on input to the first device 701, e.g., an image input from a camera, an audio input from a microphone, an interaction with the first device 701. For example, the first device 701 can use eye tracking to modify an appearance of a first image layer in the composite image based on the eye movement of a viewer. The first device 701 can change the appearance of a region on the composite image to draw the viewer's attention. In another embodiment, the first device 701 can modify the composite image based on an interaction with the first device 701. For example, a first region of a first image layer can be clickable. A click (or similar trigger, such as a touch) registered by the first device 701 can result in the first device 701 modifying the first region, e.g., changing the first region to black and white rather than full color. The click-ability can be adjusted based on the composite image as a whole. For example, a region of the composite image can have click-ability turned on or off regardless of which image layer is visible in the region. In one embodiment, the first device 701 can use metadata, e.g., a description of a desired composite image, a description of an image layer, to modify the composite image.

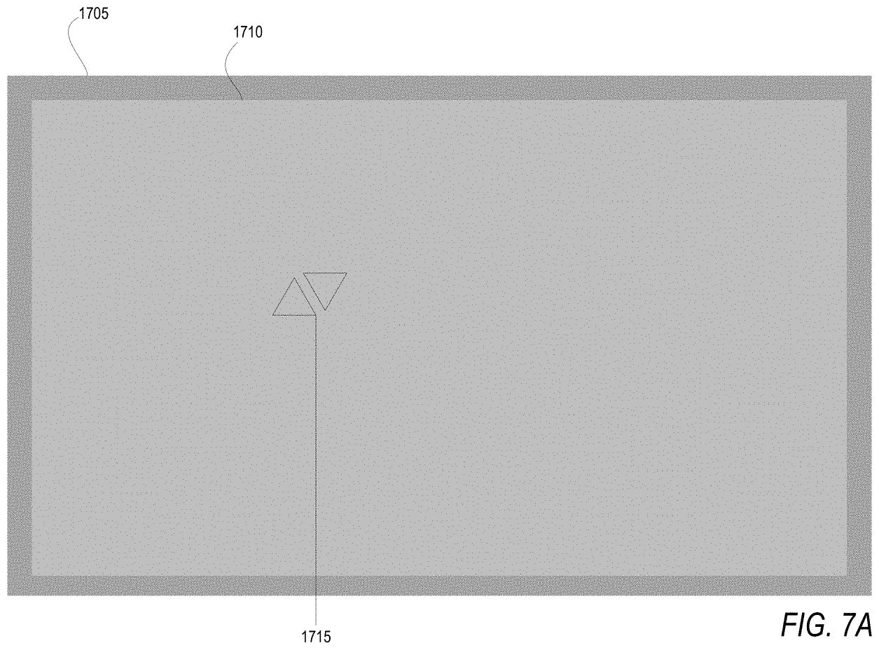

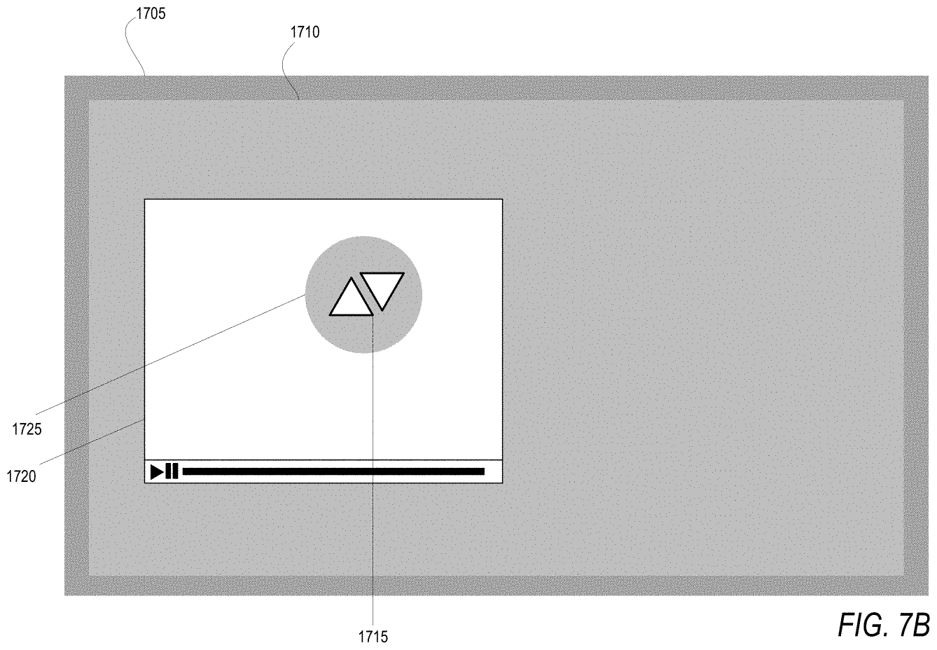

FIG. 7A illustrates an example of a viewable area 1710 of a display 1705 of a first device 701 according to one embodiment of the present invention. The viewable area 1710 can be, for example, a slide from a slide deck including an image 1715. FIG. 7B illustrates an example of a video 1720 being presented in the viewable area 1710, wherein the video 1720 is overlayed on top of the slide. The video 1720 can include a transparent region 1725 wherein the image 1715 from the slide is visible through the transparent region 1725. The image 1715 can be modified by the first device 701 to improve the visibility of the image 1715 when the video 1720 includes the transparent region 1725. For example, the contrast of the image 1715 can be adjusted so that the image 1715 stands out more against the background of the viewable area 1710 as shown in FIG. 7B. As is also illustrated by FIG. 7B, an outline of the image 1715 can be darkened so that the image 1715 is more noticeable in the viewable area 1710. The modification of the image 1715 can improve the overall visual effect of the composite image, wherein the composite image can include the video 1720 overlayed on the viewable area 1710. In one embodiment, the first device 701 displaying the viewable area 1710 can receive instructions regarding the appearance of the composite image when the video 1720 is overlayed on the viewable area 1710. For example, the instructions can include pixel values for the image 1715. In one embodiment, the first device 701 can inspect the main memory to identify the transparent region 1725 of the video 1720. The first device 701 can then adjust the contrast and outline of the image 1715 to achieve a desired composite image based on the instructions. In another embodiment, the first device 701 can inspect the main memory to identify the location of the image 1715. The first device 701 can then adjust the contrast and outline of the image 1715 in the viewable area 1710 and create the transparent region 1725 in the video 1720 to achieve the desired composite image. In one embodiment, the first device 701 can verify that the composite image matches the desired composite image using computer vision, e.g., template matching.

Video and image encoding can often involve lossy compression. For example, color data can be transformed and subsampled to reduce the amount of data that is transmitted for a single image. Color data for a uniform region can be transported as an average color for the uniform region (e.g., values in red-green-blue (RGB) color space) rather than transporting color information for each pixel. However, transporting an average color for the uniform region rather than color information for each pixel in the uniform region can result in the loss of visual information such as shadows, highlights, and varying shades within the uniform region. Lossy compression can affect image quality by eliminating individual pixel data. In one embodiment of the present invention, exact color fidelity can be important for displayed data and/or digital content. For example, a reference patch can be encoded as a different color from a surrounding region, wherein the color of the reference patch is visually indistinguishable from the surrounding region to a human observer. It can be necessary to preserve minute color differences so that a device receiving the displayed data, such as a first device 701, can identify the reference patch. For example, the first device 701 can use a template of expected color values to identify the reference patch. The first device 701 can use the template when inspecting a frame buffer or main memory. A lossy compression algorithm that takes an average of color values may compress the difference in color between the reference patch and the surrounding region, thus effectively eliminating the reference patch from the image data. In one embodiment, the image data encoding the region of the reference patch can be transported with lossless compression to preserve the reference patch.

In another example, pixel resolution and quality can be important when transporting images of text. For example, digital content retrieved as a result of a reference patch can include captions to be overlayed over displayed data. Lossy compression of the digital content can result in the captions being difficult to read when displayed. Therefore, it is desirable to develop a lossless system for transmitting and displaying image data. In one embodiment, the image data can be transmitted to the first device 701 with regional lossless compression. A portion of the image data rather than all of the image data can be transmitted using lossless compression. In one embodiment, the image data can be transmitted in a raw format, e.g., a raw video format. In one embodiment, the compression of the image data can be dynamic. Regions of the image data can be compressed with loss for a first period of time, and then compressed without loss for a second period of time, or vice versa. In one embodiment, the networked device 750 can determine when to compress the digital content with loss based on the digital content and/or the displayed data. In one embodiment, regional lossless compression can also be applied to video data.

In an example embodiment, regional transparency can be used to display sign language interpretation. In a presentation such as a speech or a concert, an interpreter can provide sign language in real time along with audible speech. When the presentation is displayed over video, e.g., a livestream, a broadcast, or a playback, it can be difficult to include sign language interpretation because of limited space in the video. For example, including a video of a sign language interpreter in the frame of a presentation may cover up important information in the presentation. Minimizing the video of the sign language interpreter can make it difficult for the audience to see the sign language properly. In addition, many forms of video content do not include sign language interpretation, which makes the video content less accessible to all audiences. Regional transparency can enable the combining of two streams of video data in order to seamlessly integrate sign language interpretation while improving the overall composite image of the two streams.

In an example embodiment, the displayed data displayed by a first device 701 can include a first video stream of a speech given by a presenter. Digital content overlayed by the first device 701 on top of the displayed data can include a second video stream of a sign language interpretation of the speech, wherein the first video stream and the second video stream are in sync. The transparency of the digital content can be adjusted so that only the sign language interpreter in the second video stream is visible, while the background surrounding the sign language interpreter in the second video stream is transparent. Additionally or alternatively, the bottom half of the sign language interpreter can be made semi-transparent if it is not needed for effective sign language interpretation. The opacity of the sign language interpreter can also be adjusted while maintaining visual clarity of the sign language interpreter. The digital content can then be positioned on top of the displayed data so that the digital content does not obscure essential visual information in the displayed data. For example, the digital content can be positioned so that the second video stream of the sign language interpreter covers empty space in the first video stream of the speech. In one embodiment, the displayed data can include both the first video stream and the second video stream. The first device 701 can overlay the two video streams. The two video streams can be stored, rendered, and/or displayed by different applications or by the same application.

In another example, the displayed data can be an emergency broadcast, wherein the emergency broadcast includes written information about evacuation routes for display on the first device 701. Audio information can accompany the emergency broadcast. The digital content can include a video of an interpreter providing a sign language interpretation of the audio information. The background of the video behind the interpreter can be made transparent so that the written information of the displayed data is still visible when the digital content is overlayed on the displayed data. In one embodiment, the displayed data can include both the emergency broadcast and the video of the interpreter. The emergency broadcast and the video of the interpreter can be stored, rendered, and/or displayed by different applications or by the same application.

The approach of regional transparency of an image or video in the present invention is distinct from typical green screen technologies. In green screen technologies, post-production editing is used to key out a colored background and create the appearance of transparency. However, in the present invention, the sign language interpreter does not have to be filmed in front of a green screen or similar background to achieve transparency. Rather, the transparency of each pixel in the digital content can be adjusted in the alpha channel by the first device 701 displaying the digital content. The transparency of any image or video can be adjusted regardless of its source or content. In addition, the implementation of regional transparency in the present invention means that the transparency of a color does not have to be uniformly set, as is the case in green screen technologies. The present approach allows for greater control in combining and displaying image data from various sources.

In one embodiment, an artificial intelligence module can be used to generate sign language interpretation when a human sign language interpreter is not available. For example, the sign language interpretation can be performed using a computer-generated avatar, e.g., a photo-realistic human figure. In one embodiment, the artificial intelligence module can generate the sign language interpretation from audio or text using at least one neural network, e.g., a mixture density network (MDN), a generative adversarial network (GAN). It is important that videos of sign language are of good quality and resolution. It is also important that the avatar can be clearly seen when it is overlayed on image data. The transparency and appearance of the image data can be adjusted to improve the visibility of the avatar without sacrificing overall image quality or obscuring underlying image data. For example, a region immediately surrounding the avatar can be kept opaque to create a high-contrast background so that the avatar can be easily seen. The size of the surrounding region and how far it extends past the avatar can be adjusted by adjusting the regional transparency of the digital content. The size of the surrounding region can also depend on images and objects in the underlying image data.

In one embodiment, the avatar performing the sign language interpretation can be overlayed onto displayed data such as a broadcast. The sign language interpretation can be generated and displayed as digital content in real time or near real time to follow along with live displayed data. Additionally or alternatively, the sign language interpretation can be generated before the displayed data is displayed rather than in real time. For example, a speech is read off of a script. The sign language interpretation can be generated using the script before the presentation of the speech. A video of the avatar performing the sign language interpretation can then be retrieved and overlayed as digital content over the speech when a video of the speech is presented in the displayed data.

In one embodiment, the sign language interpretation can be displayed as digital content using a reference patch. The first device 701 can receive displayed data, wherein the displayed data includes a reference patch. When the first device 701 identifies the reference patch, the first device 701 can be directed to retrieve digital content, e.g., from a networked device 750, as described herein. The digital content can include sign language interpretation by an avatar. In one embodiment, only devices that are set to display sign language interpretation can retrieve the digital content. The digital content can include transparent regions such that the displayed data is visible even when the sign language interpretation is overlayed on the displayed data. The regional transparency of the digital content can be adjusted over time. For example, an avatar performing sign language is opaque and can be displayed in the bottom left corner of the display at a first point in time while the rest of the digital content is transparent. At a later point in time, the avatar can be moved to the bottom right corner of the display. The bottom left corner of the digital content can become transparent, while the avatar remains opaque in the bottom right corner of the digital content.

In one embodiment, the artificial intelligence module can translate sign language to text, e.g., spoken language, written text. The artificial intelligence module can analyze image data to detect sign language and translate the gestures to text. In one embodiment, the image data can be an input into an electronic device, e.g., a video feed captured by a camera on the first device 701. In another embodiment, the image data can be received by the electronic device, e.g., via a livestream. In one embodiment, a text translation of the sign language generated by the artificial intelligence module can then be overlayed, e.g., as closed captioning, on top of the displayed data. In one embodiment, the text can be fed into a text-to-speech module, and the digital content can include an audio file of the text. In one embodiment, a networked device (e.g., a server) can implement the artificial intelligence module.

As another example embodiment, image data with regional transparency can be used for a video lecture. The first device 701 can display a slide deck. The first device 701 can also display a video feed of a presenter speaking about the slide deck and overlay the video feed onto the slide deck. The video feed can be live or prerecorded. The background surrounding the presenter in the video feed can be made transparent by the first device 701 so that only the presenter is visibly overlayed on the slide deck. In one embodiment, the first device 701 can identify a human or a human-like figure in the video feed using image recognition. For example, the first device 701 can use a neural network, e.g., a convolutional neural network, to detect the presenter in the video feed. The first device 701 can then adjust transparency of the video feed based on the location of the presenter over time. Thus, even if the presenter moves around in the video feed, the presenter will remain opaque and visible over the slide deck while the background of the video feed remains transparent and the slide deck remains visible.

In one embodiment, the first device 701 can use gesture recognition to adjust transparency of image data. As a non-limiting example, a presenter may point to text on the slide deck. Any part of the presenter's body that overlaps with the text can be made transparent so that the text remains visible. In another embodiment, the part of the presenter's body that overlaps with the text can become partially transparent. When the presenter moves away from the text, the presenter can become fully opaque. In one embodiment, the first device 701 can recognize that the presenter is using a finger in the video feed to point to a region of the slideshow. The region of the video feed indicated by the finger can become transparent to emphasize the underlying region of the slide show.

In an example embodiment, the first device 701 can use optical character recognition (OCR) to identify text in the image data, e.g., in a slide deck, in order to adjust transparency of the image data. Objects that are not recognized as text via OCR can be deprioritized so that the text of the slide deck is always visible. In another embodiment, the first device 701 can receive user input to set a transparency of the image data. For example, the first device 701 can enable a user to select a region of the image data (e.g., with a click or similar trigger) and set the transparency of the image data. Additionally or alternatively, the first device 701 can enable a user to select a region of a first image layer and set a visibility of the region relative to a second image layer. In one embodiment, user input or manual selection can be made on a second device, such as a second user device or a networked device. The user input can then be transmitted to the first device 701 displaying the image data.

In one embodiment, the first device 701 can use gesture recognition to modify the composite image of the video feed overlayed on the slide deck. For example, a presenter can make a pinching motion, often recognized as a zooming motion, in the video feed. The first device 701 can recognize the pinching motion and zoom in or out on a region of the slide deck indicated by the presenter's hand. As another, non-limiting example, the first device 701 can recognize a swiping motion made by a presenter. The swiping motion can cause an increase or decrease in a visual attribute of a region of the slideshow indicated by the swiping motion, e.g., a brightness, a contrast, a saturation. In one embodiment, the affected region indicated by a hand gesture can be a region within a radius of the hand. In another embodiment, the affected region indicated by a hand gesture can an object in the composite image. For example, the first device 701 can recognize a presenter gesturing in front of a region of a slideshow wherein the region includes a shape. The first device 701 can apply any modifications based on the gesture to the entire shape. In one embodiment, the first device 701 can identify the shape using computer vision by inspecting the frame buffer. In another embodiment, the first device 701 can identify the shape by inspecting the main memory.

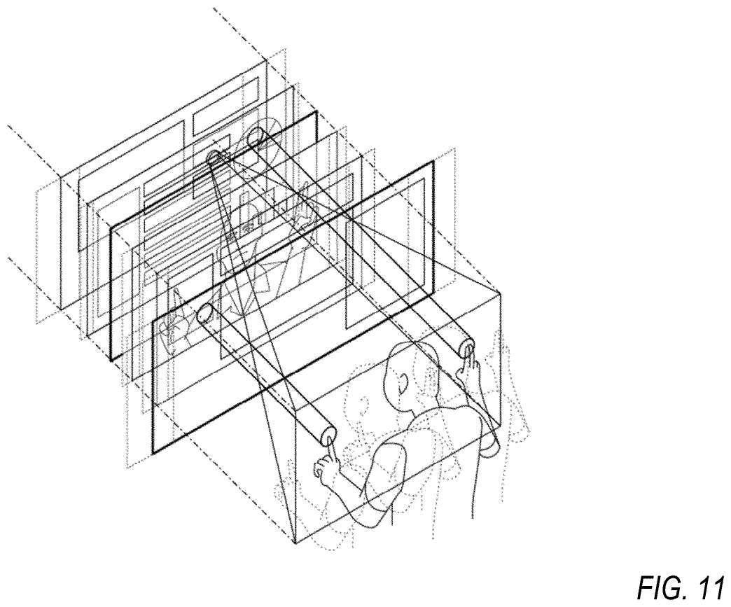

Example methods for gesture recognition include, but are not limited to, appearance-based models, three-dimensional (3D) models, skeletal models, and volumetric models. In addition to analyzing image data for gesture recognition, the first device 701 can also use input from wired gloves, controllers, electrodes, and/or additional wearables, according to one embodiment of the present invention. In one embodiment, the first device 701 can recognize a plurality of gestures simultaneously. In some embodiments, one or more of the disclosed functions and capabilities may be used to enable users to see a volumetric composite of layers of transparent computing from a 360-degree optical lenticular perspective, as shown and discussed relative to FIG. 11, where a user's gaze, gestures, movements, position, orientation, or other characteristics observed by cameras are a basis to calculate, derive and/or predict the 360-degree optical lenticular perspective from which users see the volumetric composite of layers of transparent computing displayed on displays. Further, users can engage with a 3-dimensional virtual environment displayed on displays consisting of layers of transparent computing placed behind the 3-dimensional virtual environment displayed on screens. Such 3-dimensional gesture recognition functionality may be employed with transparent video functionality as shown and discussed relative to FIGS. 6A-7B.

In some embodiments, the first device 701 implements layering of functionality within a given display frame. For example, the first device 701 may monitor user head gestures and movements in front of the computer display for head and body gestures, haptics, and movements, which can trigger various computer functionality. With the detected movement of, for example, a user's head in front of the display, the distance between layers proportionally change. For example, a head movement to closer to the display may signal zooming into a portion of the display therefore causing a different distance between two corresponding layers versus, for example, a head movement away for the display. For further details regarding layered functionality, the reader is directed to U.S. patent application Ser. No. 18/073,365, filed on Dec. 1, 2022 by Etwaru, and entitled “INTERACTIVE REALITY COMPUTING EXPERIENCE USING OPTICAL LENTICULAR MULTI-PERSPECTIVE SIMULATION”, and U.S. patent application Ser. No. 18/072,344, filed on Nov. 30, 2022, by Etwaru and entitled “INTERACTIVE REALITY COMPUTING EXPERIENCE USING OPTICAL LENTICULAR MULTI-PERSPECTIVE SIMULATION”, the contents of which are incorporated herein by reference for all purposes as though set forth in full.

In another example, regional transparency can be used in a first device 701 embedded in or connected to a vehicle display. The first device 701 can display a navigation system or vehicle settings. The first device 701 can also receive digital content in the form of a video when the first device 701 engages in a video call. The first device 701 can then overlay the video on the navigation system. In one embodiment, the first device 701 can adjust the transparency of the digital content in response to an alert generated by the first device 701 or an alert received by the first device 701. For example, a navigation alert generated by a navigation application on the first device 701 can cause the first device 701 to make the video call transparent so that a driver can see the navigation system on the vehicle display. In another example, the first device 701 can receive an emergency alert from a second device, e.g., a networked device, and the emergency alert overrides the visibility of the digital content.

Embodiments of the subject matter and the functional operations described in this specification can be implemented by digital electronic circuitry, in tangibly embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of data processing apparatus. The computer storage medium can be a machine-readable storage device, a machine-readable storage substrate, a random or serial access memory device, or a combination of one or more of them.

The term “data processing apparatus” refers to data processing hardware and may encompass all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, Subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA an ASIC.

Computers suitable for the execution of a computer program include, by way of example, general or special purpose microprocessors or both, or any other kind of central processing unit. Generally, a CPU will receive instructions and data from a read-only memory or a random access memory or both. Elements of a computer are a CPU for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more Such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients (user devices) and servers. A client and server are generally remote from each other and typically interact through a communication network. The relationship of client and server arises by virtue of computer programs running on the respective computers and having a client-server relationship to each other. In an embodiment, a server transmits data, e.g., an HTML page, to a user device, e.g., for purposes of displaying data to and receiving user input from a user interacting with the user device, which acts as a client. Data generated at the user device, e.g., a result of the user interaction, can be received from the user device at the server.

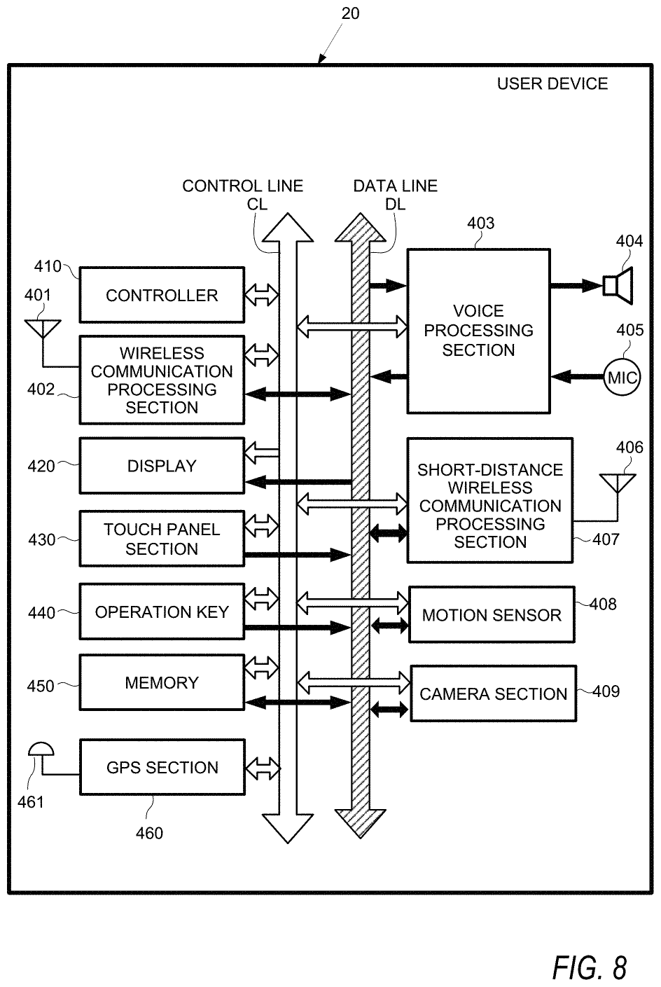

Electronic user device 20 shown in FIG. 8 can be an example of one or more of the devices shown in FIG. 1. In an embodiment, the electronic user device 20 may be a smartphone. However, the skilled artisan will appreciate that the features described herein may be adapted to be implemented on other devices (e.g., a laptop, a tablet, a server, an e-reader, a camera, a navigation device, etc.). The exemplary user device 20 of FIG. 8 includes processing circuitry, as discussed above. The processing circuitry includes one or more of the elements discussed next with reference to FIG. 8. The electronic user device 20 may include other components not explicitly illustrated in FIG. 8 such as a CPU, GPU, frame buffer, etc. A frame buffer is generally memory with a bitmap that drives a computer (video) display under the control of a CPU, a GPU, or a combination thereof. It serves as a memory buffer that includes data representing the pixels of a frame. The CPU/GPU convert the in-memory bitmap of a corresponding frame buffer into a video signal that can then be displayed. The electronic user device 20 includes a controller 410 and a wireless communication processor 402 connected to an antenna 401. A speaker 404 and a microphone 405 are connected to a voice processor 403.

The controller 410 may include one or more processors/processing circuitry (CPU, GPU, or other circuitry) and may control each element in the user device 20 to perform functions related to communication control, audio signal processing, graphics processing, control for the audio signal processing, still and moving image processing and control, and other kinds of signal processing. The controller 410 may perform these functions by executing instructions stored in a memory 450. Alternatively or in addition to the local storage of the memory 450, the functions may be executed using instructions stored on an external device accessed on a network or on a non-transitory computer readable medium.

The memory 450 includes but is not limited to Read Only Memory (ROM), Random Access Memory (RAM), or a memory array including a combination of volatile and non-volatile memory units. The memory 450 may be utilized as working memory by the controller 410 while executing the processes and algorithms of the present disclosure. Additionally, the memory 450 may be used for long-term storage, e.g., of image data and information related thereto.

The user device 20 includes a control line CL and data line DL as internal communication bus lines. Control data to/from the controller 410 may be transmitted through the control line CL. The data line DL may be used for transmission of voice data, displayed data, etc.

The antenna 401 transmits/receives electromagnetic wave signals between base stations for performing radio-based communication, such as the various forms of cellular telephone communication. The wireless communication processor 402 controls the communication performed between the user device 20 and other external devices via the antenna 401. For example, the wireless communication processor 402 may control communication between base stations for cellular phone communication.

The speaker 404 emits an audio signal corresponding to audio data supplied from the voice processor 403. The microphone 405 detects surrounding audio and converts the detected audio into an audio signal. The audio signal may then be output to the voice processor 403 for further processing. The voice processor 403 demodulates and/or decodes the audio data read from the memory 450 or audio data received by the wireless communication processor 402 and/or a short-distance wireless communication processor 407. Additionally, the voice processor 403 may decode audio signals obtained by the microphone 405.

The exemplary user device 20 may also include a display 420, a touch panel 430, an operation key 440, and a short-distance communication processor 407 connected to an antenna 406. The display 420 may be a Liquid Crystal Display (LCD), an organic electroluminescence display panel, or another display screen technology. In addition to displaying still and moving image data, the display 420 may display operational inputs, such as numbers or icons which may be used for control of the user device 20. The display 420 may additionally display a GUI for a user to control aspects of the user device 20 and/or other devices. Further, the display 420 may display characters and images received by the user device 20 and/or stored in the memory 450 or accessed from an external device on a network. For example, the user device 20 may access a network such as the Internet and display text and/or images transmitted from a Web server.

The touch panel 430 may include a physical touch panel display screen and a touch panel driver. The touch panel 430 may include one or more touch sensors for detecting an input operation on an operation surface of the touch panel display screen. The touch panel 430 also detects a touch shape and a touch area. Used herein, the phrase “touch operation” refers to an input operation performed by touching an operation surface of the touch panel display with an instruction object, such as a finger, thumb, or stylus-type instrument. In the case where a stylus or the like is used in a touch operation, the stylus may include a conductive material at least at the tip of the stylus such that the sensors included in the touch panel 430 may detect when the stylus approaches/contacts the operation surface of the touch panel display (similar to the case in which a finger is used for the touch operation).

In certain aspects of the present disclosure, the touch panel 430 may be disposed adjacent to the display 420 (e.g., laminated) or may be formed integrally with the display 420. For simplicity, the present disclosure assumes the touch panel 430 is formed integrally with the display 420 and therefore, examples discussed herein may describe touch operations being performed on the surface of the display 420 rather than the touch panel 430. However, the skilled artisan will appreciate that this is not limiting.

For simplicity, the present disclosure assumes the touch panel 430 is a capacitance-type touch panel technology. However, it should be appreciated that aspects of the present disclosure may easily be applied to other touch panel types (e.g., resistance-type touch panels) with alternate structures. In certain aspects of the present disclosure, the touch panel 430 may include transparent electrode touch sensors arranged in the X-Y direction on the surface of transparent sensor glass.

The touch panel driver may be included in the touch panel 430 for control processing related to the touch panel 430, such as scanning control. For example, the touch panel driver may scan each sensor in an electrostatic capacitance transparent electrode pattern in the X-direction and Y-direction and detect the electrostatic capacitance value of each sensor to determine when a touch operation is performed. The touch panel driver may output a coordinate and corresponding electrostatic capacitance value for each sensor. The touch panel driver may also output a sensor identifier that may be mapped to a coordinate on the touch panel display screen. Additionally, the touch panel driver and touch panel sensors may detect when an instruction object, such as a finger is within a predetermined distance from an operation surface of the touch panel display screen. That is, the instruction object does not necessarily need to directly contact the operation surface of the touch panel display screen for touch sensors to detect the instruction object and perform processing described herein. For example, in an embodiment, the touch panel 430 may detect a position of a user's finger around an edge of the display panel 420 (e.g., gripping a protective case that surrounds the display/touch panel). Signals may be transmitted by the touch panel driver, e.g. in response to a detection of a touch operation, in response to a query from another element based on timed data exchange, etc.

The touch panel 430 and the display 420 may be surrounded by a protective casing, which may also enclose the other elements included in the user device 20. In an embodiment, a position of the user's fingers on the protective casing (but not directly on the surface of the display 420) may be detected by the touch panel 430 sensors. Accordingly, the controller 410 may perform display control processing described herein based on the detected position of the user's fingers gripping the casing. For example, an element in an interface may be moved to a new location within the interface (e.g., closer to one or more of the fingers) based on the detected finger position.

Further, in an embodiment, the controller 410 may be configured to detect which hand is holding the user device 20, based on the detected finger position. For example, the touch panel 430 sensors may detect a plurality of fingers on the left side of the user device 20 (e.g., on an edge of the display 420 or on the protective casing), and detect a single finger on the right side of the user device 20. In this exemplary scenario, the controller 410 may determine that the user is holding the user device 20 with his/her right hand because the detected grip pattern corresponds to an expected pattern when the user device 20 is held only with the right hand.

The operation key 440 may include one or more buttons or similar external control elements, which may generate an operation signal based on a detected input by the user. In addition to outputs from the touch panel 430, these operation signals may be supplied to the controller 410 for performing related processing and control. In certain aspects of the present disclosure, the processing and/or functions associated with external buttons and the like may be performed by the controller 410 in response to an input operation on the touch panel 430 display screen rather than the external button, key, etc. In this way, external buttons on the user device 20 may be eliminated in lieu of performing inputs via touch operations, thereby improving watertightness.

The antenna 406 may transmit/receive electromagnetic wave signals to/from other external apparatuses, and the short-distance wireless communication processor 407 may control the wireless communication performed between the other external apparatuses. Bluetooth, IEEE 802.11, and near-field communication (NFC) are non-limiting examples of wireless communication protocols that may be used for inter-device communication via the short-distance wireless communication processor 407.

The user device 20 may include a motion sensor 408. The motion sensor 408 may detect features of motion (i.e., one or more movements) of the user device 20. For example, the motion sensor 408 may include an accelerometer to detect acceleration, a gyroscope to detect angular velocity, a geomagnetic sensor to detect direction, a geo-location sensor to detect location, etc., or a combination thereof to detect motion of the user device 20. In an embodiment, the motion sensor 408 may generate a detection signal that includes data representing the detected motion. For example, the motion sensor 408 may determine a number of distinct movements in a motion (e.g., from start of the series of movements to the stop, within a predetermined time interval, etc.), a number of physical shocks on the user device 20 (e.g., a jarring, hitting, etc., of the electronic device), a speed and/or acceleration of the motion (instantaneous and/or temporal), or other motion features. The detected motion features may be included in the generated detection signal. The detection signal may be transmitted, e.g., to the controller 410, whereby further processing may be performed based on data included in the detection signal. The motion sensor 408 can work in conjunction with a Global Positioning System (GPS) section 460. The information of the present position detected by the GPS section 460 is transmitted to the controller 410. An antenna 461 is connected to the GPS section 460 for receiving and transmitting signals to and from a GPS satellite.

The user device 20 may include a camera section 409, which includes a lens and shutter for capturing photographs of the surroundings around the user device 20. In an embodiment, the camera section 409 captures surroundings of an opposite side of the user device 20 from the user. The images of the captured photographs can be displayed on the display panel 420. A memory section saves the captured photographs. The memory section may reside within the camera section 109 or it may be part of the memory 450. The camera section 409 can be a separate feature attached to the user device 20 or it can be a built-in camera feature.

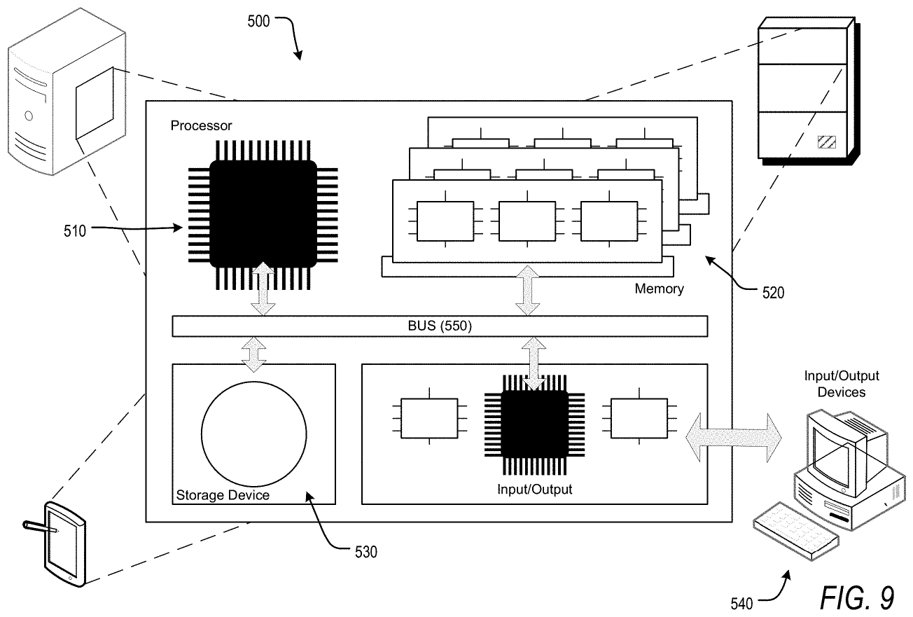

An example of a type of computer is shown in FIG. 9. The computer 500 can be used for the operations described in association with any of the computer-implement methods described previously, according to one implementation. For example, the computer 500 can be an example of devices 701, 702, 70n, 7001, or a server (such as networked device 750). In some embodiments, the computer 500 includes processing circuitry, as discussed above. The computer 500, when embodied as the networked device 750 or one of the devices 701, 702, 70n, 7001, may include other components not explicitly illustrated in FIG. 9 such as a central processing unit (CPU), graphic processing unit (GPU), frame buffer, etc. In an embodiment of the disclosure, the processing circuitry is one or a combination of a CPU, a GPU, and a frame buffer. The processing circuitry includes one or more of the elements discussed next with reference to FIG. 9. In FIG. 9, the computer 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the computer 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the computer 500. In one implementation, the storage device 530 is a computer-readable medium. In various different implementations, the storage device 530 may be a floppy disk device, a hard disk device, an optical disk device, or a tape device.

The input/output device 540 provides input/output operations for the computer 500. In one implementation, the input/output device 540 includes a keyboard and/or pointing device. In another implementation, the input/output device 540 includes a display unit for displaying graphical user interfaces.

Next, a hardware description of a device 601 according to exemplary embodiments is described with reference to FIG. 10. In FIG. 10, the device 601, which can be the above described devices of FIG. 1, includes processing circuitry, as discussed above. The processing circuitry includes one or more of the elements discussed next with reference to FIG. 10. The device 701, may include other components not explicitly illustrated in FIG. 10 such as a CPU, GPU, frame buffer, etc. In FIG. 10, the device 701 includes a CPU 600 which performs the processes described above/below. The process data and instructions may be stored in memory 602. These processes and instructions may also be stored on a storage medium disk 604 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device 601 communicates, such as a server or computer.

Further, the claimed advancements may be provided as a utility application, background daemon, or component of an operating system, or combination thereof, executing in conjunction with CPU 600 and an operating system such as Microsoft Windows, UNIX, Solaris, LINUX, Apple MAC-OS and other systems known to those skilled in the art.

The hardware elements in order to achieve the device 601 may be realized by various circuitry elements, known to those skilled in the art. For example, CPU 600 may be a Xenon or Core processor from Intel of America or an Opteron processor from AMD of America, or may be other processor types that would be recognized by one of ordinary skill in the art. Alternatively, the CPU 600 may be implemented on an FPGA, ASIC, PLD or using discrete logic circuits, as one of ordinary skill in the art would recognize. Further, CPU 600 may be implemented as multiple processors cooperatively working in parallel to perform the instructions of the processes described above. CPU 600 can be an example of the CPU illustrated in each of the devices of FIG. 1.

The device 601 in FIG. 10 also includes a network controller 606, such as an Intel Ethernet PRO network interface card from Intel Corporation of America, for interfacing with network 650 (also shown in FIG. 1), and to communicate with the other devices of FIG. 1. As can be appreciated, the network 650 can be a public network, such as the Internet, or a private network such as an LAN or WAN network, or any combination thereof and can also include PSTN or ISDN sub-networks. The network 650 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The device 601 further includes a display controller 608, such as a NVIDIA GeForce GTX or Quadro graphics adaptor from NVIDIA Corporation of America for interfacing with display 610, such as an LCD monitor. A general purpose I/O interface 612 interfaces with a keyboard and/or mouse 614 as well as a touch screen panel 616 on or separate from display 610. General purpose I/O interface also connects to a variety of peripherals 618 including printers and scanners.

A sound controller 620 is also provided in the device 601 to interface with speakers/microphone 622 thereby providing sounds and/or music.

The general purpose storage controller 624 connects the storage medium disk 604 with communication bus 626, which may be an ISA, EISA, VESA, PCI, or similar, for interconnecting all of the components of the device 601. A description of the general features and functionality of the display 610, keyboard and/or mouse 614, as well as the display controller 608, storage controller 624, network controller 606, sound controller 620, and general purpose I/O interface 612 is omitted herein for brevity as these features are known.

As shown in FIG. 11, in some embodiments, one or more of the disclosed functions and capabilities may be used to enable a volumetric composite of content-activated layers of Transparent Computing, content-agnostic layers of Transparent Computing and/or camera-captured layers of Transparent Computing placed visibly behind 2-dimensional or 3-dimensional content displayed on screens, placed in front of 2-dimensional or 3-dimensional content displayed on screens, placed inside of 3-dimensional content displayed on screens and/or placed virtually outside of the display of screens. Users can interact via Touchless Computing with any layer in a volumetric composite of layers of Transparent Computing wherein a user's gaze, gestures, movements, position, orientation, or other characteristics observed by a camera are used as the basis for selecting and interacting with objects in any layer in the volumetric composite of layers of Transparent Computing to execute processes on computing devices.

In some embodiments, one or more of the disclosed functions and capabilities may be used to enable users to see a volumetric composite of layers of transparent computing from a 360-degree optical lenticular perspective wherein a user's gaze, gestures, movements, position, orientation, or other characteristics observed by cameras are a basis to calculate, derive and/or predict the 360-degree optical lenticular perspective from which users see the volumetric composite of layers of transparent computing displayed on screens. Further, users can engage with a 3-dimensional virtual environment displayed on screens consisting of layers of transparent computing placed behind the 3-dimensional virtual environment displayed on screens, placed in front of a 3-dimensional virtual environment displayed on screens, and/or placed inside of the a 3-dimensional virtual environment displayed on screens wherein users can select and interact with objects in any layer of transparent computing to execute processes on computing devices while looking at the combination of the 3-dimensional virtual environment and the volumetric composite of layers of transparent computing from any angle of the 360-degree optical lenticular perspective (OLP) available to users.

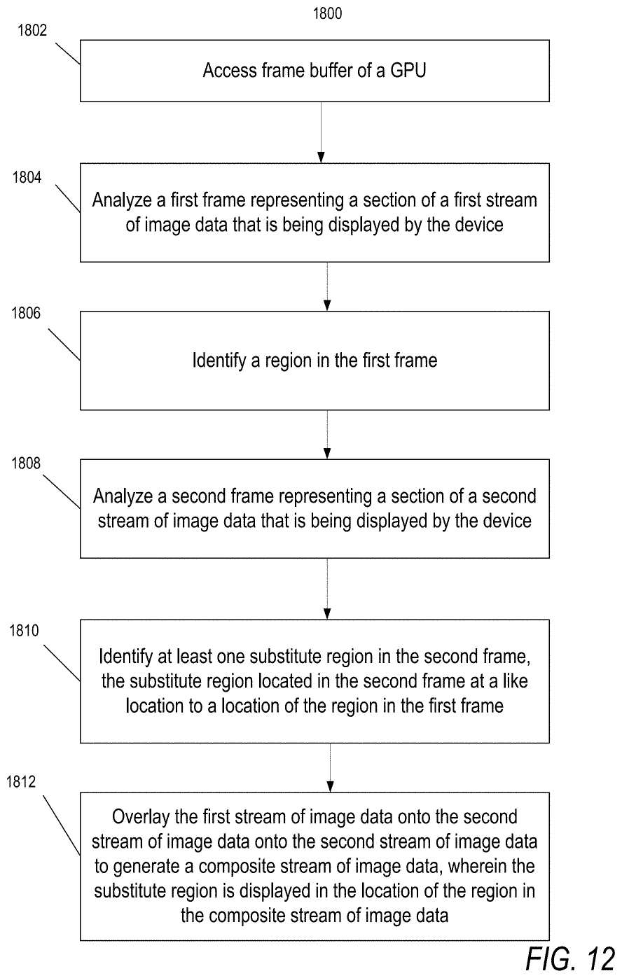

FIG. 12 is a flow chart for a method 1800 for generating a composite image including a transparent region of content of a frame that reserves an area for making visible a region of a different content of a different frame in the composite image. In an embodiment of the disclosure, a computer or computing device with a processing unit that interfaces with, includes, or is associated with a frame buffer implements method 1800. For the purpose of clarity of illustration, in an example embodiment, the first device 701 is referenced to implement the method 1800 in the discussion to follow. In step 1802, the first device 701 accesses the frame buffer of a GPU, such as shown and discussed with reference to FIG. 9. In step 1804 in FIG. 12, the first device 701 analyzes a first frame representing a section of a first stream of image data that is being displayed by the first device 701 of the frame buffer of the GPU. The first device 701 performs such analysis to identify a region in the first frame, as in step 1806. The region can be a transparent or partially transparent region. In an example embodiment, the first frame may, at least in part, represent the video 1625 with the transparent region 1630 shown in FIG. 6B. In some embodiments, the first device 701 may identify more than one transparent region. For example, the first device 701 may identify two transparent regions, one transparent region to show the text 1615 (in FIGS. 6A and 6B) and another transparent region to make visible to the audience an email address for contacting the presenter of the slide 1623.

In step 1808 of FIG. 12, the first device 701 analyzes a second frame representing a section of a second stream of image data that is being displayed by the first device 701. In an example embodiment, the second frame may represent the slide 1623 with the text 1615 shown in FIG. 6A. The first device 701 analyzes the second frame to identify a substitute region in the second frame, as in step 1810. The substitute region is located at a like location to the location of the region (e.g., the transparent region) in the first frame. In an example embodiment, the first device 701 may identify the substitute region 1629 in the second frame in FIG. 6A, which is in a location within the slide 1623 that corresponds to the location of the transparent region 1630 in the slide 1623 of the first frame in FIG. 6B. The first device 701 identifies the substitute region to effectively make the video 1625 transparent—transparent video. In some embodiments, the first device 701 may identify more than one substitute region. For example, the first device 701 may identify the substitute region 1629 to correspond to the transparent region 1630 to make the text 1615 visible and may identify another substitute region to correspond to a second transparent region to make a presenter's email address visible to the audience in the above example.

In step 1812, the first device 701 overlays the first stream of image data of the first frame onto the second stream of image data of the second frame to generate a composite stream of image data. This places the substitute region of the second frame, on the display of the first device 701, in the location of the transparent region of the first frame. Following the example of FIGS. 6A and 6B, the composite stream of image data represents the composite image 1621, shown in FIG. 6B.

While this specification contains many specific implementation details, these should not be construed as limitations on the scope of what may be claimed, but rather as descriptions of features that may be specific to particular embodiments.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Embodiments of the present disclosure may also be set forth in the following parentheticals.

(1) A device comprising processing circuitry, including a graphics processing unit (GPU), configured to: access a frame buffer of the GPU, analyze a first frame of the frame buffer of the GPU, the first frame representing a section of a first stream of image data that is being displayed by the device, identify a region in the first frame, analyze a second frame representing a section of a second stream of image data that is being displayed by the device, identify a substitute region in the second frame, wherein the substitute region is located in the second frame at a like location to a location of the region in the first frame, and overlay the first stream of image data onto the second stream of image data to generate a composite stream of image data, wherein the substitute region is displayed in the location of the region in the composite stream of image data.

(2) The device of (1), wherein the first stream of image data is received by the device from a remote device over a data communication network wherein a defined region of the first frame is in a lossless compression format and remaining regions of the first frame are in a lossy compression format.

(3) The device of (1) to (2), wherein the first stream of image data is a video.

(4) The device of (1) to (3), wherein the processing circuitry is further configured to modify a transparency of the region.

(5) The device of (1) to (4), wherein the processing is further configured to modify the transparency of the region based on an input received by the device.

(6) The device of (1) to (5), wherein the processing circuitry is further configured to modify a size and/or a location of the region.

(7) The device of (1) to (6), wherein the processing circuitry is further configured to modify the size and/or the location of the region based on the second frame of image representing the section of the second stream of image data.

(8) A method of creating a composite stream of image data, comprising: accessing a frame buffer of the GPU; analyzing a first frame representing a section of a first stream of image data that is being displayed by the device; identifying a region in the first frame; analyzing a second frame representing a section of a second stream of image data that is being displayed by the device; identifying a substitute region in the second frame, wherein the substitute region is located in the second frame at a like location to a location of the region in the first frame; and overlaying the first stream of image data onto the second stream of image data to generate a composite stream of image data, wherein the substitute region is displayed in the location of the region in the composite stream of image data.

(9) The method of (8), wherein the first stream of image data is received from a remote device over a communication network wherein a defined region of the first frame is in a lossless compression format and remaining regions of the first frame are in lossy compression format.

(10) The method of (8) to (9), wherein the first stream of image data is a video.

(11) The method of (8) to (10), further comprising modifying a transparency of the region.

(12) The method of (8) to (11), further comprising modifying the transparency of the region based on a received input.

(13) The method of (8) to (12), further comprising modifying a size and/or a location of the region.

(14) The method of (8) to (13), further comprising modifying the size and/or the location of the region based on the second frame representing the section of the second stream of image data.

(15) A non-transitory computer-readable storage medium for storing computer-readable instructions that, when executed by a computer, cause the computer to perform a method, the method comprising: accessing a frame buffer of the GPU; analyzing a first frame representing a section of a first stream of image data that is being displayed by the device; identifying a region in the first frame; analyzing a second frame representing a section of a second stream of image data that is being displayed by the device; identifying at least one substitute region in the second frame, wherein the substitute region is located in the second frame at a like location to a location of the region in the first frame; and overlaying the first stream of image data onto the second stream of image data to generate a composite stream of image data, wherein the substitute region is displayed in the location of the region in the composite stream of image data.

(16) The non-transitory computer-readable storage medium of (15), wherein the first stream of image data is a video.

(17) The non-transitory computer-readable storage medium of (15) to (16), further comprising modifying a transparency of the region.

(18) The non-transitory computer-readable storage medium of (15) to (17), further comprising modifying the transparency of the region based on a received input.

(19) The non-transitory computer-readable storage medium of (15) to (18), further comprising modifying a size and/or a location of the region.

(20) The non-transitory computer-readable storage medium of (15) to (19), further comprising modifying the size and/or the location of the region based on the second frame representing the section of the second stream of image data.

Thus, the foregoing discussion discloses and describes merely exemplary embodiments of the present disclosure. As will be understood by those skilled in the art, the present disclosure may be embodied in other specific forms without departing from the spirit thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

1. A device comprising processing circuitry, including a graphics processing unit (GPU), configured to:
access a frame buffer of the GPU,
analyze a first frame of the frame buffer of the GPU, the first frame representing a section of a first stream of image data that is being displayed by the device,
identify a region in the first frame,
analyze a second frame representing a section of a second stream of image data that is being displayed by the device,
identify a substitute region in the second frame, wherein the substitute region is located in the second frame at a like location to a location of the region in the first frame, and
overlay the first stream of image data onto the second stream of image data to generate a composite stream of image data, wherein the substitute region is displayed in the location of the region in the composite stream of image data.

2. The device of claim 1, wherein the first stream of image data is received by the device from a remote device over a data communication network wherein a defined region of the first frame is in a lossless compression format and remaining regions of the first frame are in a lossy compression format.

3. The device of claim 1, wherein the first stream of image data is a video.

4. The device of claim 1, wherein the processing circuitry is further configured to modify a transparency of the region.

5. The device of claim 4, wherein the processing is further configured to modify the transparency of the region based on an input received by the device.

6. The device of claim 1, wherein the processing circuitry is further configured to modify a size and/or a location of the region.

7. The device of claim 6, wherein the processing circuitry is further configured to modify the size and/or the location of the region based on the second frame of image representing the section of the second stream of image data.

8. A method of creating a composite stream of image data, comprising:
accessing a frame buffer of the GPU;
analyzing a first frame representing a section of a first stream of image data that is being displayed by the device;
identifying a region in the first frame;
analyzing a second frame representing a section of a second stream of image data that is being displayed by the device;
identifying a substitute region in the second frame, wherein the substitute region is located in the second frame at a like location to a location of the region in the first frame; and
overlaying the first stream of image data onto the second stream of image data to generate a composite stream of image data, wherein the substitute region is displayed in the location of the region in the composite stream of image data.

9. The method of claim 8, wherein the first stream of image data is received from a remote device over a communication network wherein a defined region of the first frame is in a lossless compression format and remaining regions of the first frame are in lossy compression format.

10. The method of claim 8, wherein the first stream of image data is a video.

11. The method of claim 8, further comprising modifying a transparency of the region.

12. The method of claim 11, further comprising modifying the transparency of the region based on a received input.

13. The method of claim 8, further comprising modifying a size and/or a location of the region.

14. The method of claim 13, further comprising modifying the size and/or the location of the region based on the second frame representing the section of the second stream of image data.

15. A non-transitory computer-readable storage medium for storing computer-readable instructions that, when executed by a computer, cause the computer to perform a method, the method comprising:
accessing a frame buffer of the GPU;
analyzing a first frame representing a section of a first stream of image data that is being displayed by the device;
identifying a region in the first frame;
analyzing a second frame representing a section of a second stream of image data that is being displayed by the device;
identifying at least one substitute region in the second frame, wherein the substitute region is located in the second frame at a like location to a location of the region in the first frame; and
overlaying the first stream of image data onto the second stream of image data to generate a composite stream of image data, wherein the substitute region is displayed in the location of the region in the composite stream of image data.

16. The non-transitory computer-readable storage medium of claim 15, wherein the first stream of image data is a video.

17. The non-transitory computer-readable storage medium of claim 15, further comprising modifying a transparency of the region.

18. The non-transitory computer-readable storage medium of claim 17, further comprising modifying the transparency of the region based on a received input.

19. The non-transitory computer-readable storage medium of claim 15, further comprising modifying a size and/or a location of the region.

20. The non-transitory computer-readable storage medium of claim 19, further comprising modifying the size and/or the location of the region based on the second frame representing the section of the second stream of image data.
